(19) United States
(12) Patent Application Publication
(10) Pub. No.: US 2026/0205861 A1
(43) Pub. Date: Jul. 16, 2026

(54) ANTENNA AUGMENTATION FOR DOWNLINK COMMUNICATIONS

(71) Applicant: QUALCOMM Incorporated, San Diego, CA (US)

(72) Inventors: Daniel PAZ, Atlit (IL); Michael LEVITSKY, Rehovot (IL); Gideon Shlomo KUTZ, Ramat Hasharon (IL); Amit BAR-OR TILLINGER, Tel-Aviv (IL)

(21) Appl. No.: 19/020,967

(22) Filed: Jan. 14, 2025

(51) Int. Cl. H04W 28/02; H04L 5/00; H04W 28/18; H04W 72/40; H04W 72/543

(52) U.S. Cl. CPC H04W 28/0215; H04L 5/0055; H04W 28/18; H04W 72/40; H04W 72/543

(57) ABSTRACT

Various aspects of the present disclosure generally relate to wireless communication. In some aspects, a user equipment (UE) may transmit, to a network node, capability information indicating an antenna augmentation capability of the UE. The UE may transmit, to the network node, an indication of a companion device that supports antenna augmentation for the UE. The UE may receive, from the network node, configuration information indicating one or more channel state feedback (CSF) report formats that support antenna augmentation. Numerous other aspects are described.

### FIELD OF THE DISCLOSURE

Aspects of the present disclosure generally relate to wireless communication and specifically relate to techniques, apparatuses, and methods associated with antenna augmentation for downlink communications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be individually or collectively configured to cause the UE to transmit, to a network node, capability information indicating an antenna augmentation capability of the UE. The one or more processors may be individually or collectively configured to cause the UE to transmit, to the network node, an indication of a companion device that supports antenna augmentation for the UE. The one or more processors may be individually or collectively configured to cause the UE to receive, from the network node, configuration information indicating one or more channel state feedback (CSF) report formats that support antenna augmentation.

Some aspects described herein relate to a network node for wireless communication. The network node may include one or more memories and one or more processors coupled to the one or more memories. The one or more processors may be individually or collectively configured to cause the network node to receive, from a UE, capability information indicating an antenna augmentation capability of the UE. The one or more processors may be individually or collectively configured to cause the network node to receive, from the UE, an indication of a companion device that supports antenna augmentation for the UE. The one or more processors may be individually or collectively configured to cause the network node to transmit, to the UE, configuration information indicating one or more CSF report formats that support antenna augmentation.

Some aspects described herein relate to a companion device for wireless communication. The companion device may include one or more memories and one or more processors coupled to the one or more memories. The one or more processors may be individually or collectively configured to cause the companion device to transmit, to a UE, capability information indicating a capability of the companion device for supporting antenna augmentation for the UE. The one or more processors may be individually or collectively configured to cause the companion device to receive, from the UE, at least one channel state information reference signal (CSI-RS) resource configuration. The one or more processors may be individually or collectively configured to cause the companion device to receive, from a network node, a CSI-RS associated with the at least one CSI-RS resource configuration. The one or more processors may be individually or collectively configured to cause the companion device to transmit, to the UE, CSI-RS samples associated with the CSI-RS.

Some aspects described herein relate to a method of wireless communication performed by a UE. The method may include transmitting, to a network node, capability information indicating an antenna augmentation capability of the UE. The method may include transmitting, to the network node, an indication of a companion device that supports antenna augmentation for the UE. The method may include receiving, from the network node, configuration information indicating one or more CSF report formats that support antenna augmentation.

Some aspects described herein relate to a method of wireless communication performed by a network node. The method may include receiving, from a UE, capability information indicating an antenna augmentation capability of the UE. The method may include receiving, from the UE, an indication of a companion device that supports antenna augmentation for the UE. The method may include transmitting, to the UE, configuration information indicating one or more CSF report formats that support antenna augmentation.

Some aspects described herein relate to a method of wireless communication performed by a companion device. The method may include transmitting, to a UE, capability information indicating a capability of the companion device for supporting antenna augmentation for the UE. The method may include receiving, from the UE, at least one CSI-RS resource configuration. The method may include receiving, from a network node, a CSI-RS associated with the at least one CSI-RS resource configuration. The method may include transmitting, to the UE, CSI-RS samples associated with the CSI-RS.

Some aspects described herein relate to a non-transitory computer-readable medium that stores a set of instructions for wireless communication by a UE. The set of instructions, when executed by one or more processors of the UE, may cause the UE to transmit, to a network node, capability information indicating an antenna augmentation capability of the UE. The set of instructions, when executed by one or more processors of the UE, may cause the UE to transmit, to the network node, an indication of a companion device that supports antenna augmentation for the UE. The set of instructions, when executed by one or more processors of the UE, may cause the UE to receive, from the network node, configuration information indicating one or more CSF report formats that support antenna augmentation.

Some aspects described herein relate to a non-transitory computer-readable medium that stores a set of instructions for wireless communication by a network node. The set of instructions, when executed by one or more processors of the network node, may cause the network node to receive, from a UE, capability information indicating an antenna augmentation capability of the UE. The set of instructions, when executed by one or more processors of the network node, may cause the network node to receive, from the UE, an indication of a companion device that supports antenna augmentation for the UE. The set of instructions, when executed by one or more processors of the network node, may cause the network node to transmit, to the UE, configuration information indicating one or more CSF report formats that support antenna augmentation.

Some aspects described herein relate to a non-transitory computer-readable medium that stores a set of instructions for wireless communication by a companion device. The set of instructions, when executed by one or more processors of the companion device, may cause the companion device to transmit, to a UE, capability information indicating a capability of the companion device for supporting antenna augmentation for the UE. The set of instructions, when executed by one or more processors of the companion device, may cause the companion device to receive, from the UE, at least one CSI-RS resource configuration. The set of instructions, when executed by one or more processors of the companion device, may cause the companion device to receive, from a network node, a CSI-RS associated with the at least one CSI-RS resource configuration. The set of instructions, when executed by one or more processors of the companion device, may cause the companion device to transmit, to the UE, CSI-RS samples associated with the CSI-RS.

Some aspects described herein relate to an apparatus for wireless communication. The apparatus may include means for transmitting, to a network node, capability information indicating an antenna augmentation capability of the apparatus. The apparatus may include means for transmitting, to the network node, an indication of a companion device that supports antenna augmentation for the apparatus. The apparatus may include means for receiving, from the network node, configuration information indicating one or more CSF report formats that support antenna augmentation.

Some aspects described herein relate to an apparatus for wireless communication. The apparatus may include means for receiving, from a UE, capability information indicating an antenna augmentation capability of the UE. The apparatus may include means for receiving, from the UE, an indication of a companion device that supports antenna augmentation for the UE. The apparatus may include means for transmitting, to the UE, configuration information indicating one or more CSF report formats that support antenna augmentation.

Some aspects described herein relate to an apparatus for wireless communication. The apparatus may include means for transmitting, to a UE, capability information indicating a capability of the apparatus for supporting antenna augmentation for the UE. The apparatus may include means for receiving, from the UE, at least one CSI-RS resource configuration. The apparatus may include means for receiving, from a network node, a CSI-RS associated with the at least one CSI-RS resource configuration. The apparatus may include means for may include transmitting, to the UE, CSI-RS samples associated with the CSI-RS.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of sidelink communications and access link communications, in accordance with the present disclosure.

FIG. 4 is a diagram illustrating an example of downlink antenna augmentation using a companion device, in accordance with the present disclosure.

FIG. 5 is a diagram illustrating an example associated with antenna augmentation for downlink communications, in accordance with the present disclosure.

FIG. 6 is a diagram illustrating an example process performed, for example, at a user equipment (UE) or an apparatus of a UE, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a companion device or an apparatus of a companion device, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication network, a network node may communicate with a user equipment (UE) via an access link (e.g., via a Uu interface). Access link communications between the network node and the UE may include downlink communications (from the network node to the UE) and uplink communications (from the UE to the network node). In some examples, two or more UEs may communicate directly with one another using sidelink communications (for example, without communicating by way of a network node as an intermediary). For example, sidelink communications may be used for communications between a UE and one or more companion devices. Companion devices may include wearable UEs (e.g., fitness trackers, extended reality (XR) goggles and/or headsets, smartwatches, smart glasses, smart clothing, and/or personal medical monitors), smart home UEs, internet-of-things (IoT) devices, reduced capability (RedCap) UEs, and/or any other UE that supports or enhances the functionality of a primary UE. “Primary UE” refers to a main UE and/or a target UE that is performing a primary function (e.g., communicating, web browsing, messaging, system navigation, or any other interaction with a core functionality of the device) for a user and may be relative to the usage and type of interaction that the user has with the device.

Currently, due to a small form factor of a UE, UE antennas are typically highly correlated, which limits a communication channel rank and an overall throughput for access link communications between a network node and a UE. In some examples, one or more companion devices may be used to augment communications performed via access link between a network node and a UE (e.g., a primary UE) by communicating receive (Rx) antenna samples to the UE. In such examples, antennas on the companion devices may be used as augmentation antennas (e.g., additional or alternative antennas) for the UE. For example, one or multiple companion devices may receive data from the network node 110 and share local Rx antenna samples with the UE via sidelink communications. For example, the sidelink communications may be between the UE and the companion device and may be over an unlicensed (e.g., ultra-wideband (UWB)) frequency band or over a licensed frequency band (e.g., an FR2 frequency band and/or an FR3 frequency band). Such antenna augmentation for downlink communications may improve throughput (via increased rank), coverage, and/or reliability of downlink communications.

In some examples, a UE and a companion device providing antenna augmentation for the UE may be connected to a wireless communication network via the same network node and may be synchronized on the downlink timing of the network node. However, UE antenna augmentation procedures may be mostly transparent to the network node. In some examples, the communication between the UE and the companion device that is paired or tethered with the UE may be via standardized or proprietary sidelink with autonomous UE-driven management and with a minimum network awareness for sidelink related procedures (e.g., to keep minimal any extra network-scheduler-related complexity for antenna augmentation support). In some examples, because an antenna augmentation scheme may come with increased latency and/or timing limitations and increased complexity on the UE side (e.g., due to the extra time required to transfer the samples from the companion device to the UE and to process the samples at the UE), it may be desirable that such antenna augmentation be employed under adequate conditions, and a dynamic activation of the antenna augmentation scheme may be advantageous. However, such dynamic activation of antenna augmentation by the UE may have implications for timing and latency parameters, such as a downlink control information (DCI)-to-physical downlink shared channel (PDSCH) timing parameter and/or a PDSCH-to-acknowledgement (ACK) or negative ACK (NACK) (ACK/NACK) timing parameter. In such examples, the network node may not be aware of the dynamic activation of the antenna augmentation, and the network node may schedule communications with timing and latency parameters that are incompatible with the antenna augmentation scheme. As a result, throughput, reliability, and/or coverage of downlink communications may be decreased.

Various aspects relate generally to antenna augmentation for downlink communications. Some aspects more specifically relate to communications (e.g., physical (PHY) layer communications) for supporting Uu downlink communications assisted by antenna augmentation. In some aspects, a UE may transmit, to a network node, capability information indicating an antenna augmentation capability of the UE. The UE may pair with a companion device that supports antenna augmentation for the UE, and the UE may transmit, to the network node, an indication of the companion device that supports antenna augmentation for the UE. The UE may receive, from the network node, configuration information indicating one or more channel state feedback (CSF) report formats that support antenna augmentation.

Particular aspects of the subject matter described in this disclosure can be implemented to realize one or more of the following potential advantages. In some examples, by the UE transmitting the capability information indicating the antenna augmentation capability of the UE, the described techniques can be used to inform the network node of capabilities of the UE, such as minimum timing and latency restrictions for downlink communication assisted by antenna augmentation for the UE. In some examples, by configuring the UE with one or more CSF report formats that support antenna augmentation, the described techniques can be used to enable the UE to provide a CSF report that supports downlink communications assisted by antenna augmentation for the UE. Such CSF reporting that supports antenna augmentation may enable the UE and/or the network node to dynamically enable or disable antenna augmentation for the UE on a per downlink allocation basis. As a result, the UE and the network node can control antenna augmentation to be enabled in conditions conducive to antenna augmentation, which may result in improved throughput, coverage, and reliability for downlink communications.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

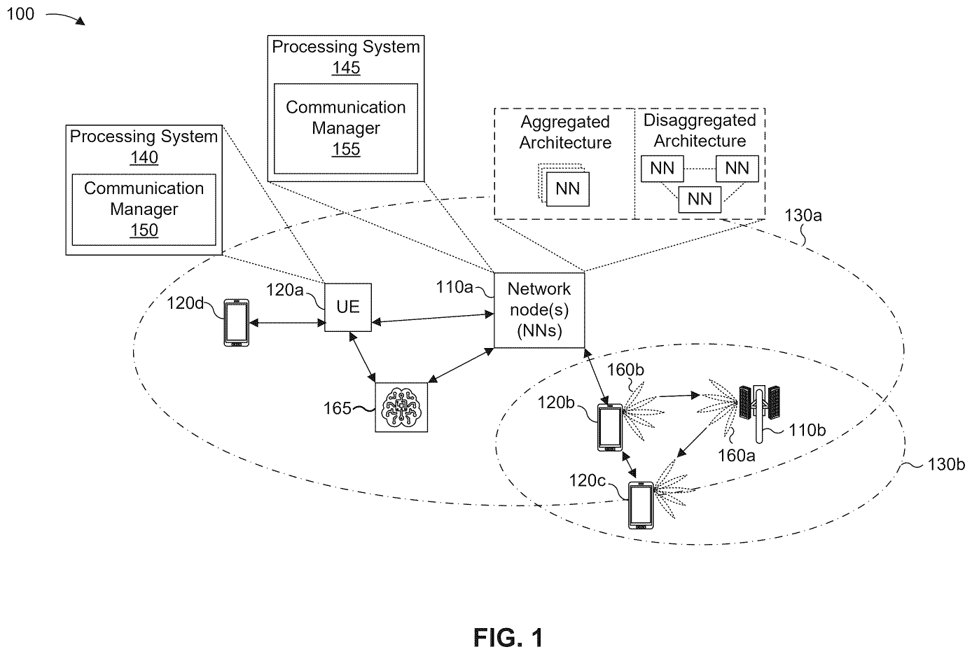

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

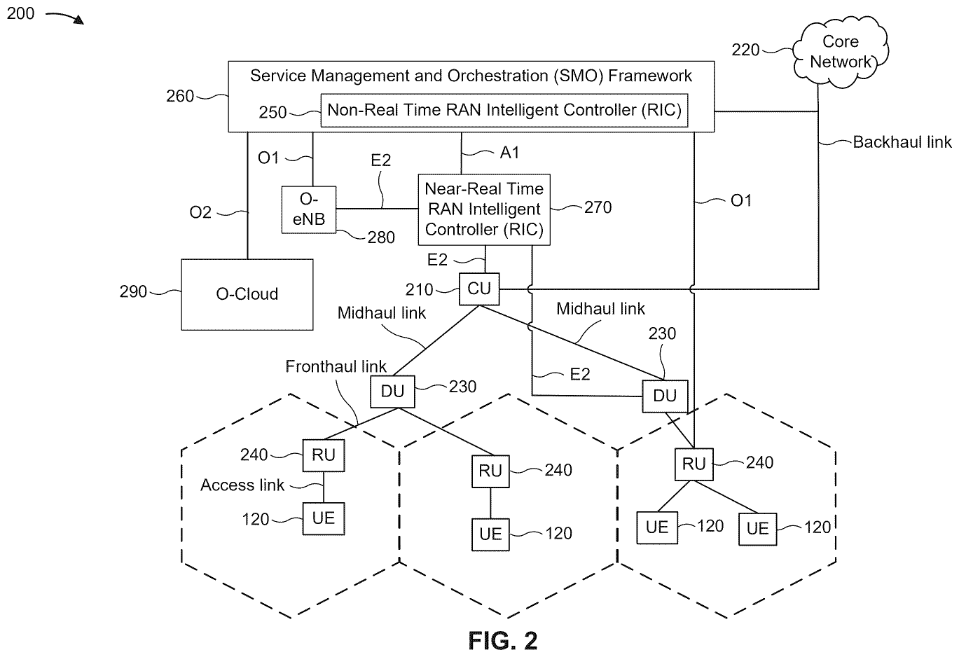

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

In some examples, two or more UEs 120 (for example, shown as UE 120a and UE 120d) may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110, which then transmits the data to the UE 120d in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs 120 to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may transmit, to a network node, capability information indicating an antenna augmentation capability of the UE; transmit, to the network node, an indication of a companion device that supports antenna augmentation for the UE; and receive, from the network node, configuration information indicating one or more CSF report formats that support antenna augmentation.

Additionally, or alternatively, as described in more detail elsewhere herein, the communication manager 150 may transmit, to another UE, capability information indicating a capability for supporting antenna augmentation for the other UE; receive, from the other UE, at least one CSI-RS resource configuration; receive, from a network node, a CSI-RS associated with the at least one CSI-RS resource configuration; and transmit, to the other UE, CSI-RS samples associated with the CSI-RS. Additionally, or alternatively, the communication manager 150 may perform one or more other operations described herein.

In some aspects, the network node 110 may include a communication manager 155. As described in more detail elsewhere herein, the communication manager 155 may receive, from a UE, capability information indicating an antenna augmentation capability of the UE; receive, from the UE, an indication of a companion device that supports antenna augmentation for the UE; and transmit, to the UE, configuration information indicating one or more CSF report formats that support antenna augmentation. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

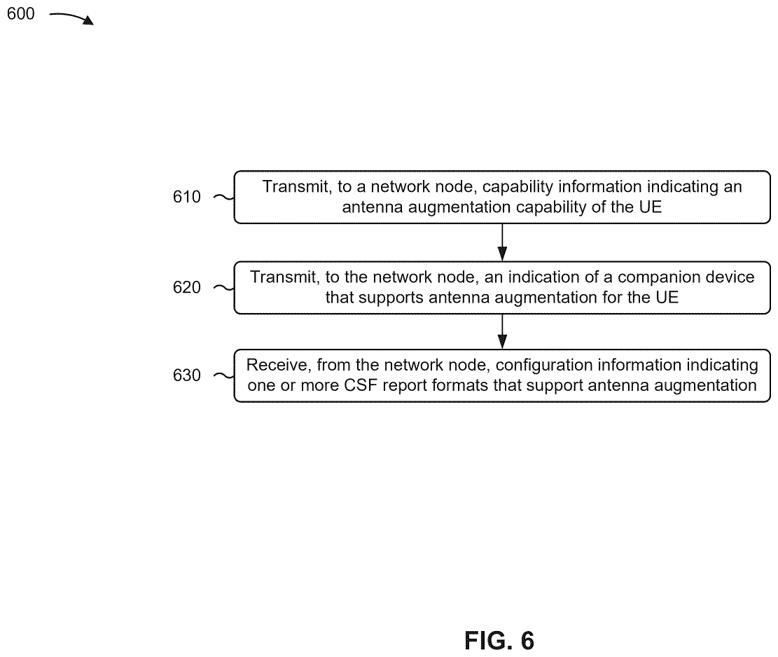

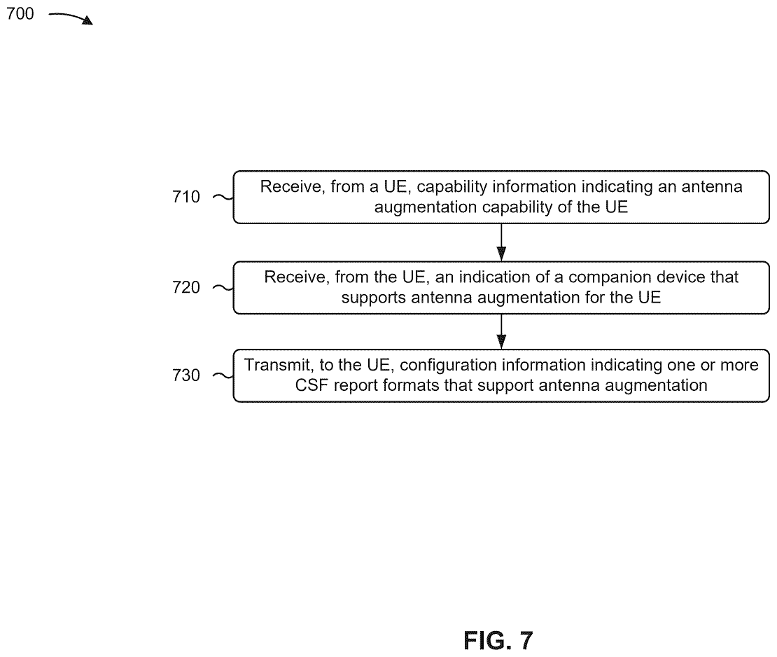

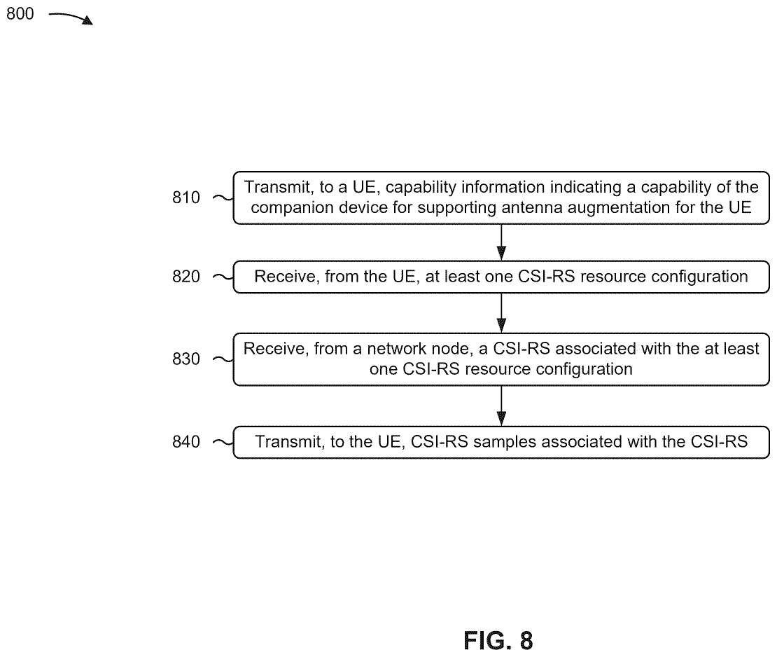

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with antenna augmentation for downlink communications, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, or other processes as described herein (alone or in conjunction with one or more other processors). In some aspects, the companion device described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, and/or interpreting the instructions, among other examples.

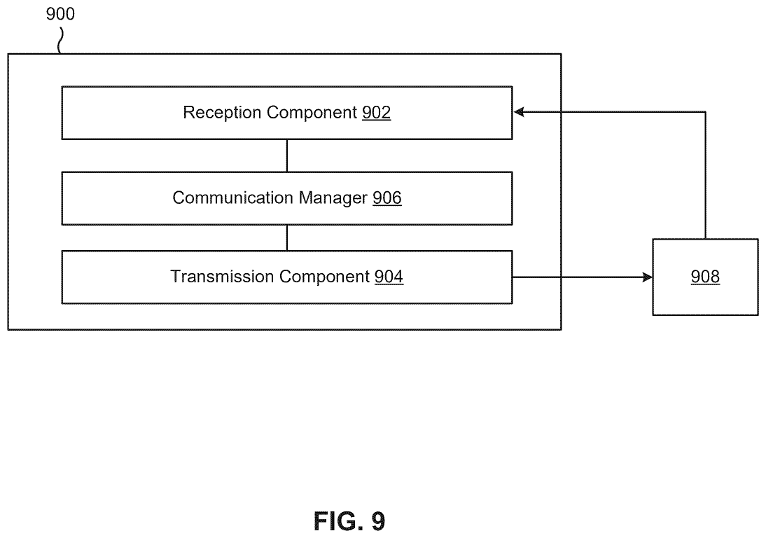

In some aspects, a UE (e.g., the UE 120) includes means for transmitting, to a network node, capability information indicating an antenna augmentation capability of the UE; means for transmitting, to the network node, an indication of a companion device that supports antenna augmentation for the UE; and/or means for receiving, from the network node, configuration information indicating one or more CSF report formats that support antenna augmentation. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

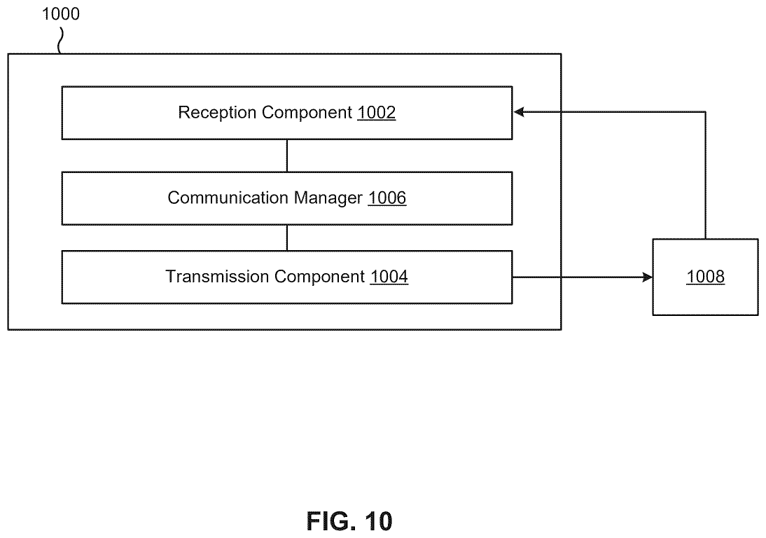

In some aspects, a network node (e.g., the network node 110) includes means for receiving, from a UE, capability information indicating an antenna augmentation capability of the UE; means for receiving, from the UE, an indication of a companion device that supports antenna augmentation for the UE; and/or means for transmitting, to the UE, configuration information indicating one or more CSF report formats that support antenna augmentation. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

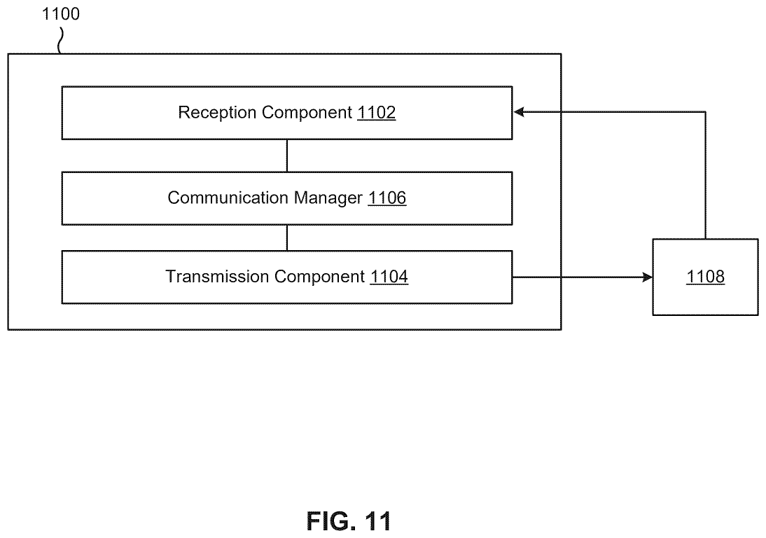

In some aspects, a companion device (e.g., the UE 120) includes means for transmitting, to a UE, capability information indicating a capability of the companion device for supporting antenna augmentation for the UE; means for receiving, from the UE, at least one CSI-RS resource configuration; means for receiving, from a network node, a CSI-RS associated with the at least one CSI-RS resource configuration; and/or means for transmitting, to the UE, CSI-RS samples associated with the CSI-RS. In some aspects, the means for the companion device to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

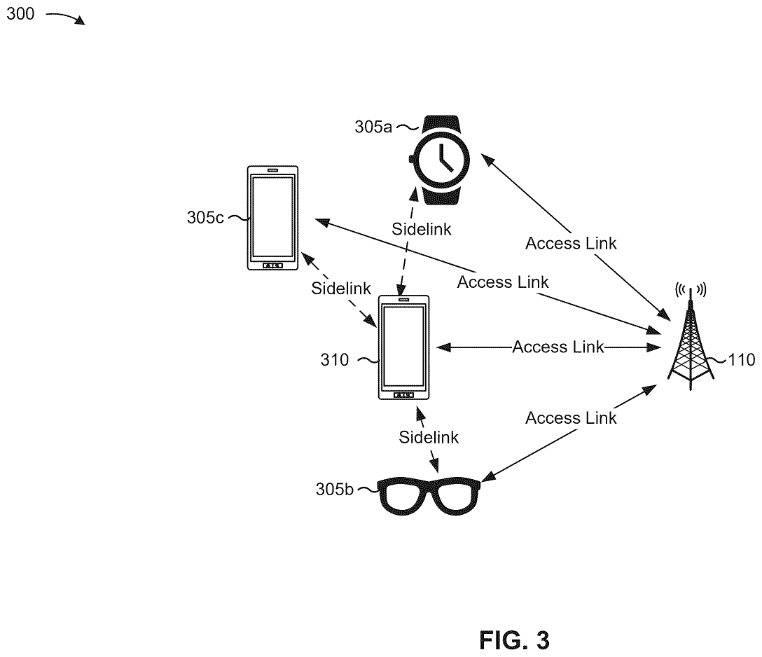

FIG. 3 is a diagram illustrating an example 300 of sidelink communications and access link communications, in accordance with the present disclosure. As wireless communication applications and use cases expand, it may come to pass that some users of a primary UE 310 may carry and/or use one or more companion devices 305, such as wearable devices, that communicate directly with a network node 110 in addition to the primary UE 310.

As shown in FIG. 3, a primary UE 310, and companion devices 305, including a smart watch 305a, smart glasses 305b (e.g., XR glasses), and/or an auxiliary UE 305c may communicate with one another via a sidelink. For example, the primary UE 310 may communicate with each of the companion devices 305 via sidelink communications in an unlicensed (e.g., UWB) or licensed (e.g., FR2 or FR3) frequency band. Additionally, or alternatively, the primary UE 310 and the companion devices 305 may be part of a personal area network (PAN) and may communicate with each other via a communication protocol (e.g., Bluetooth or Bluetooth low energy (BLE), among other examples) associated with the PAN. As further shown in FIG. 3, the network node 110 may communicate with the primary UE 310 and the companion devices 305 via an access link. The primary UE 310 may correspond to one or more UEs described elsewhere herein, such as the UE 120 of FIG. 1. The companion devices 305 may correspond to one or more companion devices described elsewhere herein, and each companion device 305 may be an example of a UE 120. For example, the UE 305c may include a UE (e.g., such as UE 120 described in connection with FIG. 1), such as a wearable UE, a companion UE, and/or an auxiliary UE that augments one of more functions of the primary UE 310a. A direct link between the primary UE 310 and a companion device 305 (e.g., via a PC5 interface) may be referred to as a sidelink (or a PC5 link), and a direct link between a network node 110 and the primary UE 310 or a companion device 305 (e.g., via a Uu interface) may be referred to as an access link (or a Uu link). Sidelink communications (e.g., PC5 communications) may be transmitted via the sidelink, and access link communications (e.g., Uu communications) may be transmitted via the access link. An access link communication may be either a downlink communication (from a network node 110 to the primary UE 310 and/or a companion device 305) and/or an uplink communication (from the primary UE 310 and/or a companion device 305 to a network node 110).

In some examples, the companion devices 305 may be used to augment communications performed via access link between the network node 110 and the primary UE 310, by communicating receiver antenna samples to the primary UE 310. For example, one or multiple companion devices 305 (e.g., the smart watch 305a, the smart glasses 305b, and/or the UE 305c, among other examples), may receive data from the network node 110 and share local receive (Rx) samples with the primary UE 310 via licensed (e.g., FR2 and/or FR3) and/or unlicensed (e.g., UWB) high-throughput sidelink. In this way, antennas of the companion devices 305 may be used as augmentation antennas (e.g., additional or alternative antennas) for the primary UE 310. Such antenna augmentation for downlink communications may improve throughput (via increased rank), coverage, and/or reliability of downlink communications.

As indicated above, FIG. 3 is provided as an example. Other examples may differ from what is described with respect to FIG. 3.

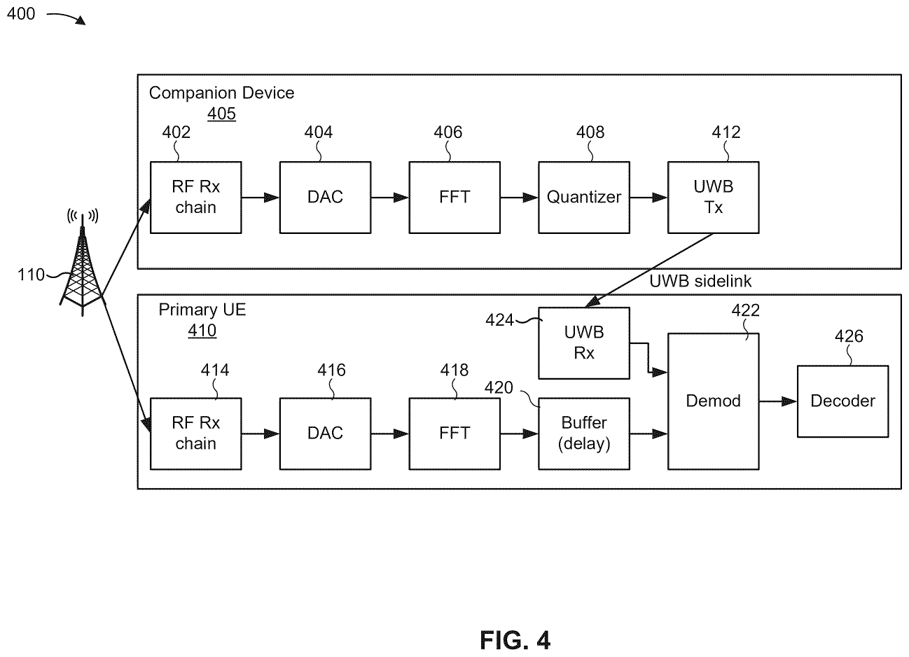

FIG. 4 is a diagram illustrating an example 400 of downlink antenna augmentation using a companion device, in accordance with the present disclosure. Example 400 includes a companion device 405 (e.g., companion device 305 and/or UE 120), a primary UE 410 (e.g., primary UE 310 and/or UE 120), and a network node 110. The companion device 405 may provide antenna augmentation for the primary UE 410. That is, the companion device 405 (e.g., one or more antennas of the companion device 405) may be used as augmentation antennas for the primary UE 410.

The network node 110 may transmit a downlink communication (e.g., a PDSCH communication) for the primary UE 410 in a direction of the primary UE 410. For example, the primary UE 410 may be a target destination of the downlink communication. The primary UE 410 may receive the downlink communication. In order to provide antenna augmentation for the primary UE in the downlink direction, the companion device 405 may also receive the downlink communication transmitted by the network node 110 in the direction of the primary UE 410. In some examples, the primary UE 410 may receive (e.g., via one or more antennas of the primary UE 410) one or more first signals associated with the downlink communication (e.g., a first portion of the downlink communication), and the companion device 405 may receive (e.g., via one or more antennas of the companion device 405) one or more second signals associated with the downlink communication (e.g., a second portion of the downlink communication). The companion device 405 may extract samples of the received downlink communication (e.g., samples of the received one or more second signals associated with the downlink communication) and transmit the samples to the primary UE 410 via a sidelink communication.

As shown in FIG. 4, the downlink communication (e.g., the one or more second signals) received by the companion device 405 via one or more antennas of the companion device 405 may be processed by an RF Rx chain 402, a digital-to-analog converter (DAC) 404, an FFT component 406, and a quantizer 408 of the companion device 405 in order to extract the samples from the downlink communication (e.g., the one or more second signals). A UWB transmitter 412 of the companion device 405 may transmit the samples to the primary UE 410 in a UWB sidelink communication. In some other examples, the companion device 405 may use another type of sidelink communication (e.g., in a different sidelink frequency band) to transmit the samples to the primary UE 410. In some examples, the samples may correspond to extracted resource elements (REs). In some other examples, the samples may correspond to entire OFDM symbols.

As further shown in FIG. 4, the downlink communication (e.g., the one or more first signals) received by the primary UE 410 may be processed by an RF chain 414, a DAC 416, and an FFT component 418 of the primary UE 410 and output to a buffer 420 of the primary UE 410. The processed signal(s) that are input to the buffer 420 from the FFT component 418 may be output from the buffer 420 and input to a demodulator 422 of the primary UE 410 after a time delay. The time delay may provide time for the companion device 405 to process the downlink communication (e.g., the one or more first signals) and transmit the samples to the primary UE 410. A UWB receiver 424 of the primary UE 410 may receive the samples transmitted in the UWB sidelink communication (or another type of sidelink communication) from the companion device 405, and the samples may be input to the demodulator 422 of the primary UE 410. The demodulator 422 may demodulate the signals (e.g., input from the buffer 420) received and processed by the primary UE 410 and the samples received from the companion device 405, and a decoder 426 of the primary UE 410 may decode the downlink communication (e.g., the PDSCH communication) based at least in part on the demodulated signals received and processed by the primary UE 410 and the demodulated samples received from the companion device 405.

As indicated above, FIG. 4 is provided as an example. Other examples may differ from what is described with respect to FIG. 4.

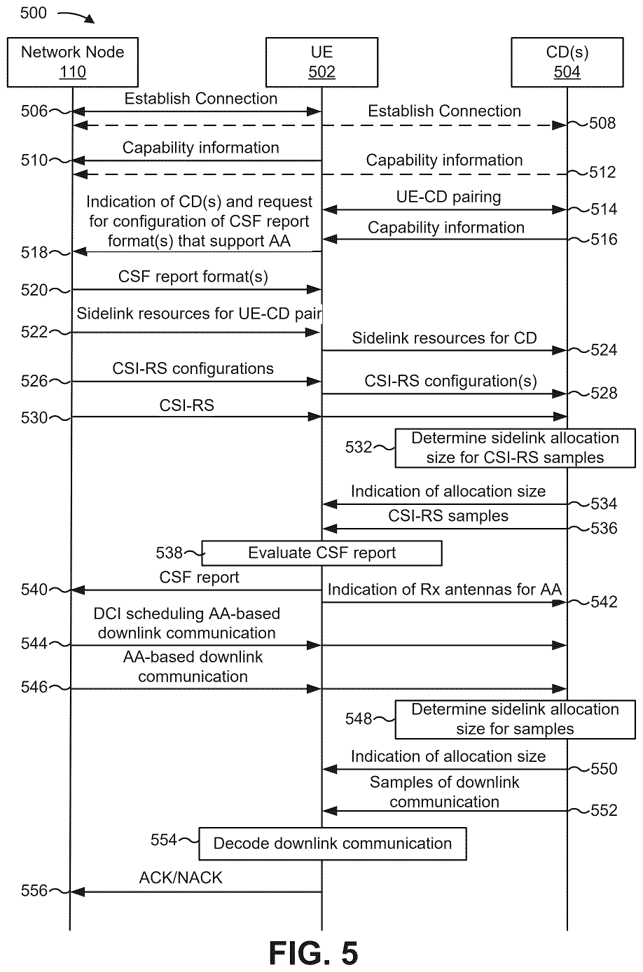

FIG. 5 is a diagram illustrating an example 500 associated with antenna augmentation for downlink communications, in accordance with the present disclosure. As shown in FIG. 5, example 500 includes communication between a network node 110, a UE 502, and one or more companion devices (CDs) 504. The UE 502 may be a first UE (e.g., UE 120) and the CD 504 may be a second UE (e.g., UE 120). In some aspects, the UE 502 may correspond to a primary UE described elsewhere herein, such as the primary UE 310 described in connection with FIG. 3 and/or the primary UE 410 described in connection with FIG. 4. The one or more CDs 504 may correspond to one or companion devices described elsewhere herein, such as the companion devices 305 described in connection with FIG. 3 and/or the companion device 405 described in connection with FIG. 4. In some aspects, the network node 110, the UE 502, and the CD 504 may be included in a wireless communication network, such as wireless communication network 100. The network node 110 may communicate with the UE 502 and the CD 504 via wireless access links, which may include uplinks and downlinks. The UE 502 and the CD 504 may communicate via a sidelink. In some aspects, the UE 502 and the CD 504 may communicate via UWB sidelink communications (e.g., via sidelink communications in an unlicensed frequency band). In some other aspects, the UE 502 and the CD 504 may communicate via sidelink communications in a licensed frequency band (e.g., F2 or F3), or via sidelink communications in a PAN (e.g., via Bluetooth or BLE, among other examples).

As shown in FIG. 5, and by reference number 506, the UE 502 may establish a connection with the network node 110 (e.g., over a Uu link). For example, the UE 502 may establish an RRC connection with the network node 110. The UE 502 and the network node 110 may communicate to establish a connection (e.g., an RRC connection) between the UE 502 and the network node 110. For example, the UE 502 and the network node 110 may communicate to perform an initial access procedure or a handover procedure, among other examples, to establish the connection (e.g., the RRC connection) between the UE 502 and the network node 110.

As further shown in FIG. 5, and by reference number 508, in some aspects, the CD 504 may establish a connection with the network node 110 (e.g., over a Uu link). For example, the CD 504 may establish an RRC connection with the network node 110. The CD 504 and the network node 110 may communicate to establish a connection (e.g., an RRC connection) between the CD 504 and the network node 110. For example, the CD 504 and the network node 110 may communicate to perform an initial access procedure or a handover procedure, among other examples, to establish the connection (e.g., the RRC connection) between the CD 504 and the network node 110.

As further shown in FIG. 5, and by reference number 510, the UE 502 may transmit, and the network node 110 may receive, capability information (e.g., UE capability information) associated with the UE 502. For example, the UE 502 may transmit, and the network node 110 may receive, a capability report indicating the capability information associated with the UE 502. In some aspects, the capability information associated with the UE 502 may indicate an antenna augmentation (AA) capability of the UE 502. For example, the capability information may indicate whether the UE 502 supports antenna augmentation.

In some aspects, the capability information may indicate one or more other capabilities associated with supporting antenna augmentation. In some examples, the capability information may indicate a minimum latency constraint for scheduling a downlink communication associated with antenna augmentation (e.g., for Uu downlink allocation scheduling involving antenna augmentation). For example, the minimum latency constraint for downlink allocation scheduling associated with antenna augmentation may indicate a minimum value for a DCI-to-PDSCH timing offset (e.g., K0) for a downlink communication involving antenna augmentation. In some examples, the capability information may indicate a minimum latency constraint for decoding a downlink communication associated with antenna augmentation (e.g., for Uu downlink allocation decoding involving antenna augmentation). For example, the minimum latency constraint for decoding a downlink communication associated with antenna augmentation may indicate a minimum UE PDSCH processing procedure time (e.g., N1) for a downlink communication involving antenna augmentation. In some examples, the capability information may indicate a minimum latency constraint for ACK or NACK (ACK/NACK) feedback reporting for a downlink communication (e.g. a Uu downlink allocation) associated with antenna augmentation. For example, the minimum latency constraint for ACK/NACK feedback reporting for a downlink communication associated with antenna augmentation may indicate a minimum PDSCH-to-ACK/NACK timing offset (e.g., K1) for a downlink communication involving antenna augmentation. In some examples, the capability information may indicate a minimum latency constraint for extended CSF reporting associated with antenna augmentation. For example, the minimum latency constraint for extended CSF reporting may indicate a minimum latency for reporting periodic, semi-periodic, and/or aperiodic CSF to enable the UE 502 to process CSF for multiple possible combinations of antennas of one or more CDs 504.

As further shown in FIG. 5, and by reference number 512, in some aspects, the CD 504 may transmit, and the network node 110 may receive, capability information (e.g., CD capability information) associated with the CD 504. For example, the CD 504 may transmit, and the network node 110 may receive, a capability report indicating the capability information associated with the CD 504. In some examples, each CD 504 of multiple CDs 504 may transmit, to the network node 110, a respective capability report indicating respective capability information associated with that CD 504. In some aspects, the CD capability information may indicate a capability of the CD 504 for supporting antenna augmentation for the UE 502.

In some aspects, the CD capability information may indicate one or more other capabilities associated with supporting antenna augmentation. In some examples, the CD capability information may indicate a maximum number of augmentation antennas to be shared for antenna augmentation for the UE 502 (e.g., a maximum number, supported by the CD 504, of augmentation antennas that the CD 504 can share). In some examples, the CD capability information may indicate a minimum latency constraint for sharing samples of a downlink signal. The minimum latency constraint may indicate a minimum amount of time (e.g., for processing a received downlink signal to extract samples for the received downlink signal) between receiving the downlink signal (e.g., a Uu downlink CSI-RS or a Uu downlink data communication) and transmitting the samples via a sidelink communication. In some examples, the CD capability information may indicate a capability of the CD 504 for extracting frequency domain resources before sharing samples of a downlink signal. For example, the CD capability information may indicate that the CD 504 has the capability to extract a relevant Uu downlink allocation bandwidth or CSI-RS frequency domain resources before sharing the samples (e.g., the capability to extract samples of a downlink allocation or CSI-RS at an RE level), or the CD capability information may indicate that the CD 504 has the capability for sharing full Uu downlink CC bandwidth samples only (e.g., the capability to extract samples of a downlink allocation or CSI-RS at an OFDM symbol level). In some example, the CD capability information may indicate a time domain or a frequency domain supported for sharing samples of a downlink signal. In some examples, the CD capability information may indicate a supported transmit (Tx) waveform for sharing samples of a downlink signal. For example, the Tx waveform may be based on a standard scheme with channel coding, or the Tx waveform may be based on FD repetition without channel coding.

As further shown in FIG. 5, and by reference number 514, the UE 502 and the CD 504 may pair with each other. For example, the UE 502 and the CD 504 may communicate to establish a connection (e.g., a UE-CD link) between the UE 502 and the CD 504 over the sidelink. In some examples, the UE 502 and the CD 504 may communicate to establish a sidelink (e.g., PC5) connection over UWB or a sidelink connection over F2 or F3.

As shown by reference number 516, the CD 504 may transmit, and the UE 502 may receive, capability information (e.g., the CD capability information) associated with the CD 504. For example, the CD 504 may transmit, and the UE 502 may receive, a capability report indicating the CD capability information. In some examples, each CD 504 of multiple CDs 504 may transmit, to the UE 502, a respective capability report indicating respective CD capability information associated with that CD 504. In some aspects, the CD capability information transmitted from the CD 504 to the UE 502 may be the same as the CD capability information transmitted for the CD 504 to the network node 110. For example, the CD capability information may indicate a capability of the CD 504 for supporting antenna augmentation for the UE 502 and/or one or more other capabilities associated with supporting antenna augmentation, as described above in connection with reference number 512.

As further shown in FIG. 5, and by reference number 518, the UE 502 may transmit, and the network node 110 may receive, an indication of a CD 504 that supports antenna augmentation for the UE 502 (or multiple CDs 504 that support antenna augmentation for the UE 502). For example, the UE 502 may indicate, to the network node 110, that the UE 502 is paired with one or more CDs 504 that support antenna augmentation for the UE 502. In some aspects, the indication transmitted by the UE 502 may indicate a CD identifier (ID) for each paired CD 504 that supports antenna augmentation for the UE 502. In some aspects, the indication may include a request for a configuration of one or more CSF report formats (e.g., CSI report formats) that support antenna augmentation (e.g., one or more CSF report formats that can be used for reporting CSF that supports downlink antenna augmentation). For example, the UE 502 may transmit, to the network node 110, a request to be configured with one or more CSF (or CSI) report formats that support antenna augmentation, and the request may indicate one or more CD IDs that identify one or more CDs 504 that are paired with the UE 502 and support antenna augmentation for the UE 502. In some examples, the UE 502 may transmit the request to be configured with the one or more CSF report formats that support antenna augmentation and/or the indication of the CD ID(s) based on, responsive to, or otherwise in association with pairing with one or more CDs 504 and receiving CD capability information indicating that the one or more CDs 504 support antenna augmentation for the UE 502. In some aspects, the UE 502 may indicate the CD ID for the CD 504 to the network node 110 such that the CD ID can be used by the network node 110 for aperiodic CSF scheduling associated with antenna augmentation, as described in greater detail elsewhere herein.

As further shown in FIG. 5, and by reference number 520, the network node 110 may transmit, and the UE 502 may receive, configuration information indicating one or more CSF report formats that support antenna augmentation. The CSF report formats that support antenna augmentation (also referred to as “AA-supporting CSF report formats”) may be CSF report formats for reporting CSF in support of downlink transmissions with antenna augmentation. In some examples, the network node 110 may configure the UE 502 with the one or more CSF report formats that support antenna augmentation (e.g., by transmitting the configuration information indicating the one or more CSF formats that support antenna augmentation) based at least in part on (e.g., responsive to) receiving the request to configure the UE 502 with one or more CSF report formats that support antenna augmentation. In some aspects, each CSF report format that supports antenna augmentation may be indicated by a respective CSI report configuration included in the configuration information.

In some aspects, the configuration information may also indicate one or more CSF formats that do not support antenna augmentation. That is, the network node 110 may configure the UE 502 with the one or more CSF formats that support antenna augmentation and one or more other CSF formats that do not support antenna augmentation. The CSF formats that do not support antenna augmentation may be CSF formats for reporting CSF in support of downlink transmissions without antenna augmentation. In some aspects, each CSF report format that does not support antenna augmentation may be indicated by a respective CSI report configuration included in the configuration information.

In some aspects, as supporting antenna augmentation may result in relaxed latency restrictions related to Uu communications (e.g., relaxed latency restrictions for scheduling a downlink communication, decoding a downlink communication, reporting feedback for a downlink communication, and/or reporting CSF, as discussed in connection with reference number 510), antenna augmentation may be dynamically enabled or disabled for the UE 502 (e.g., by the UE 502 or the network node 110) on a per downlink allocation basis. In such examples, to support this type of dynamic antenna augmentation switching, the network node 110 may configure the UE 502 with one or more CSF report formats (e.g., CSI report configurations) with an option for antenna augmentation (e.g., the one or more CSF report formats that support antenna augmentation) and one or more CSF report formats (e.g., CSI report configurations) without an option for antenna augmentation (e.g., the one or more CSF report formats that do not support antenna augmentation). This enables the UE 502 to report different types of CSF reports (e.g., CSF reports for downlink transmissions with antenna augmentation and CSF reports for downlink transmissions without antenna augmentation), and enables the network node 110 to differentiate between the different types of CSF reports such that the network node 110 may determine different Tx parameters (e.g., MCS, RI, and PMI) for downlink transmissions for the UE 502 with and without antenna augmentation.

As further shown in FIG. 5, and by reference number 522, the network node 110 may transmit, and the UE 502 may receive, a configuration of a set of sidelink resources associated the UE 502 and the CD(s) 504 paired with the UE 502. For example, UWB sidelink resources may be coordinated (e.g., assigned or allocated) by the network (e.g., the network node 110) to avoid any mutual interference between co-located UE-CD pairs. In some examples, the network node 110 may assign sidelink resources to multiple UEs for communicating with companion devices paired with the multiple UEs. In some aspects, the network node 110 may assign a respective set of sidelink resources to each UE-CD pair. As used herein, “UE-CD pair” may refer to a pairing between a UE (e.g., the UE 502) and one or more companion devices (e.g., the one or more CDs 504). Accordingly, a UE-CD pair may include a UE and one or multiple companion devices associated with (e.g., paired with) the UE. In some examples, the network node 110 may assign each UE-CD pair (e.g., of a plurality of UE-CD pairs in a geographic location) a set of dedicated non-overlapping time domain and frequency domain resources for UWB sidelink communications. In some aspects, the configuration of the set of sidelink resources that is received by the UE 502 may indicate a set of sidelink resources (e.g., time domain and frequency domain sidelink resources) that are assigned to the UE-CD pair including the UE 502 and the one or more CDs 504 paired with the UE 502. In some aspects, the set of sidelink resources may include a sidelink resources grid (e.g., a grid of time domain and frequency domain sidelink resources) to be used for sidelink communications between the UE 502 and the CD(s) 504. For example, the sidelink resources grid may be a grid of UWB sidelink resources. In some examples, the set of sidelink resources (e.g., the sidelink resources in the sidelink resources grid) configured for the UE-CD pair (e.g., for the UE 502 and the CD(s) 504) may be accessed immediately without channel sensing or listen-before-talk (LBT) procedures.

As shown by reference number 524, the UE 502 may transmit, and the CD 504 may receive, an indication of sidelink resources, of the set of sidelink resources, for the CD 504. In some examples, in a case in which the UE 502 is paired with multiple CDs 504 that support antenna augmentation for the UE 502, the UE 502 may transmit, to each CD 504 of the multiple CDs 504, a respective indication of sidelink resources, of the set of sidelink resources, for that CD 504. In some aspects, the network node 110 may configure the set of sidelink resources (e.g., the sidelink resources grid) to the UE 502 (e.g., as described in connection with reference number 522), and the UE 502 may determine and configure how sidelink communications for different CDs 504 paired with the UE 502 are multiplexed in the set of sidelink resources for sidelink communications from the UE 502 to the CD(s) 504 (referred to as “sidelink downlink”) and sidelink communications from the CD(s) 504 to the UE 502 (referred to as “sidelink uplink”). For example, the UE 502 may transmit, to each CD 504 paired with the UE 502, a semi-persistent configuration of sidelink resources, of the set of sidelink resources, to be used by that CD 504 for sidelink downlink (e.g., for reception of sidelink communications from the UE 502) and sidelink uplink (e.g., for transmission of sidelink communications to the UE 502). Such a semi-persistent configuration may provide configured grant or grant free scheduling of sidelink communications to reduce latency and power consumption of the sidelink communications. In some aspects, after the set of sidelink resources (e.g., UWB sidelink resources) are assigned to the UE 502 by the network node 110, the local sidelink management may be performed autonomously without network involvement until there is a re-assignment request or event. In some examples, the sidelink resources (e.g., UWB sidelink resources) configured for the CD 504 may be accessed by the CD 504 without prior channel sensing or LBT procedures. In some examples, utilization of the assigned sidelink resources may be limited, depending on the volume/quantity of antenna augmentation assisted downlink allocations for the UE 502.

As further shown in FIG. 5, and by reference number 526, the network node 110 may transmit, and the UE 502 may receive, one or more CSI-RS configurations. The one or more CSI-RS configurations may include one or more CSI-RS resource configurations. In some examples, the one or more CSI-RS configurations may include configurations (e.g., RRC configurations) of periodic, semi-persistent, and/or CSI-RS resources. In some aspects, the UE 502 may receive, from the network node 110, multiple CSI-RS resource configurations including one or more CSI-RS resource configurations associated with CSF reports (e.g., CSI reports) supporting antenna augmentation and one or more CSI-RS resource configurations associated with CSF reports (e.g., CSI reports) that do not support antenna augmentation. In some aspects, the one or more CSI-RS resource configurations associated with CSF reports supporting antenna augmentation may include one or more periodic CSI-RS resource configurations, one or more semi-persistent CSI-RS resource configurations, and/or one or more aperiodic CSI-RS resource configurations.

As shown by reference number 528, the UE 502 may transmit, and the CD 504 may receive, at least one CSI-RS configuration of the one or more CSI-RS configurations received by the UE 502 from the network node 110. For example, the UE 502 may transmit, and the CD 504 may receive, at least one CSI-RS resource configuration of the one or more CSI-RS resource configurations received by the UE 502 from the network node 110. In some aspects, the UE 502 may transmit, to the CD 504, configurations (e.g., RRC configurations) for relevant periodic, semi-persistent, and/or aperiodic CSI-RS resources associated with CSF reports (e.g., CSI reports) supporting antenna augmentation. For example, in a case in which the UE 502 receives, from the network node 110, one or more CSI-RS resource configurations associated with CSF reports supporting antenna augmentation and one or more CSI-RS resource configurations associated with CSF reports (e.g., CSI reports) that do not support antenna augmentation, the UE 502 may transmit, to the CD 504, the one or more CSI-RS resource configurations associated with the CSF reports supporting antenna augmentation. In this case, the one or more CSI-RS resource configurations transmitted to the CD 504 from the UE 502 may include one or more periodic CSI-RS resource configurations associated with CSF reports that support antenna augmentation, one or more semi-persistent CSI-RS resource configurations associated with CSF reports that support antenna augmentation, and/or one or more aperiodic CSI-RS resource configurations associated with CSF reports that support antenna augmentation. The UE 502 may transmit, to the CD 504, the CSI-RS resource configurations associated with CSF reports that support antenna augmentation to configure the CD 504 to know which Uu CSI-RS resources to sample and share with the UE 502 for CSF evaluation for a CSF report that supports antenna augmentation.

In some aspects, in a case in which the UE 502 transmits, to the CD 504, an aperiodic CSI-RS resource configuration associated with an aperiodic CSI-RS, the UE 502 may transmit, to the CD 504, context information for decoding DCI that schedules the aperiodic CSI-RS and an indication of one or more CSI (or CSF) triggering states that are linked to the CSF report(s) that support antenna augmentation and are associated with the aperiodic CSI-RS resource configuration. The context information may include a configuration context (e.g., one or more RRC parameters configured for the UE 502) for decoding the DCI that schedules the aperiodic CSI-RS. For example, the context information may include one or more RRC parameters, configured for the UE 502, that enable decoding of the DCI that schedules the aperiodic CSI-RS (and/or DCI that schedules a downlink communication associated with antenna augmentation) and extraction of scheduling information from the DCI, but are not indicated in the DCI. In some aspects, the indication of one or more CSI triggering states may include a list of CSI triggering states that are activated for the UE 502 (or a list including a subset of the CSI triggering states that are activated for the UE 502).

As further shown in FIG. 5, and by reference number 530, the network node 110 may transmit a CSI-RS. The CSI-RS may be associated with CSI-RS resource allocation (e.g., the at least one CSI-RS resource allocation) that the UE 502 transmitted to the CD 504. For example, the CSI-RS may be associated with a CSI-RS resource allocation that is associated with (e.g., that triggers) a CSF report that supports antenna augmentation. That is, the CSI-RS may be a CSI-RS intended for the UE 502 for a CSF evaluation that supports antenna augmentation. The UE 502 may receive the CSI-RS.

In some aspects, the CD 504 may also receive the CSI-RS based at least in part on the CSI-RS being associated with the CSI-RS resource allocation that the UE 502 transmitted to the CD 504. The CSI-RS may be a periodic CSI-RS, a semi-persistent CSI-RS, or an aperiodic CSI-RS. In some examples, in a case in which the CSI-RS is a periodic CSI-RS (e.g., associated with a periodic CSF/CSI report) or semi-persistent CSI-RS (e.g. associated with a semi-persistent CSF/CSI report), the Uu reception timing for receiving the CSI-RS may be determined by the CD 504 in accordance with the CSI-RS resource configuration provided to the CD 504 by the UE 502. In some other examples, in a case in which the CSI-RS is an aperiodic CSI-RS (e.g., associated with an aperiodic CSF/CSI report), the aperiodic CSI-RS may be scheduled/triggered by DCI transmitted by the network node 110, and the CD 504 may determine the Uu reception timing for receiving the aperiodic CSI-RS by decoding the DCI that schedules/triggers the aperiodic CSI-RS. For example, once the relevant CSI triggering state is triggered by the corresponding DCI that schedules the aperiodic CSI-RS, the CD may be able to determine which aperiodic resources to sample and share with the UE 502 for the CSF evaluation that supports antenna augmentation. In some aspects, the DCI that schedules the aperiodic CSI-RS may be transmitted, by the network node 110, and received, by the UE 502 and the CD 504, via dedicated DCI signaling associated with antenna augmentation. For example, the dedicated DCI signaling may be companion device oriented DCI signaling dedicated to AA-supporting UE allocations, and the dedicated DCI signaling may be used for AA-supporting UE data (e.g., PDSCH) allocations and for AA-related aperiodic CSF triggering and corresponding aperiodic CSI-RS resource allocation tracking in Uu downlink by the CD 504. In some aspects, the CD 504 may decode the DCI based at least in part on the context information for decoding the DCI transmitted to the CD 504 by the UE 502.

The CD 504 may extract samples of the CSI-RS (referred to as CSI-RS samples) and share the CSI-RS samples with the UE 502. For example, the CD 504 may extract and share the CSI-RS samples in a similar manner as described above in connection with FIG. 4. In some examples, only the relevant CSI-RS REs are extracted, sampled, compressed, and forwarded to the UE 502 over sidelink by the CD 504. In some other examples, the entire OFDM symbols are extracted, sampled, compressed, and forwarded to the UE 502 over sidelink by the CD 504. The sampling of the entire OFDM symbol may be less efficient than sampling the CSI-RS REs, but the sampling of the entire OFDM symbol allows for a direct time domain sampling for lower complexity at the CD 504.

As further shown in FIG. 5, and by reference number 532, the CD 504 may autonomously determine a sidelink allocation size for sharing the CSI-RS samples. For example, the CD 504 may autonomously determine (e.g., calculate or select) an allocation size for a sidelink communication including the CSI-RS samples. In some examples, the CD 504 may determine (e.g., calculate or select) the allocation size based at least in part on context information received by the CD 504 from the UE 502 (e.g., context information configured to the CD 504 by the UE 502).

As shown by reference number 534, the CD 504 may transmit, and the UE 502 may receive, an indication of the allocation size. In some aspects, the CD 504 may indicate the allocation size for the sidelink communication including the CSI-RS samples in sidelink control information that precedes the sidelink communication including the CSI-RS samples. For example, the CD 504 may transmit, and the UE 502 may receive, sidelink control information that indicates the allocation size of the sidelink communication including the CSI-RS samples prior to transmission of the sidelink communication including the CSI-RS samples.

As shown by reference number 536, the CD 504 may transmit, and the UE 502 may receive, the CSI-RS samples. For example, the CD 504 may transmit, and the UE 502 may receive, a sidelink communication (e.g., a PSSCH communication) including the CSI-RS samples. The size of the sidelink communication including the CSI-RS samples may correspond to the allocation size indicated in the sidelink control information prior to the transmission of the sidelink communication. In some aspects, the CD 504 may transmit the sidelink communication including the CSI-RS samples at a time offset from reception of the CSI-RS in accordance with a sidelink transmission timing rule. In such examples, the CD 504 and the UE 502 may derive the sidelink transmission timing (for the CD 504) and reception timing (for the UE 502) relative to the Uu CSI-RS reception based at least in part on the sidelink transmission timing rule. For example, the sidelink transmission timing rule may be a predefined sidelink transmission timing rule. In some examples, the sidelink transmission timing rule may indicate the time offset between reception of the CSI-RS and the transmission of the sidelink communication including the CSI-RS samples. In some examples, sidelink channel access by the CD 504 can be immediate on the sidelink resources semi-persistently configured for the CD 504 by the UE 502. In such examples, the sidelink transmission timing rule enables the UE 502 to align the reception of the sidelink communication including the CSI-RS samples with the transmission of the sidelink communication by the CD 504. In some examples, the CSI-RS samples may include samples of extracted REs of the CSI-RS or samples of entire OFDM symbols of the CSI-RS.

As further shown in FIG. 5, and by reference number 538, the UE 502 may evaluate a CSF report. In some aspects, after receiving the CSI-RS samples from the CD 504, the UE 502 may evaluate CSF for a CSF report associated with a CSF report format that supports antenna augmentation. For example, the CSI-RS may be associated with (e.g., may trigger) a CSF report associated with a CSF report format of the one or more CSF report formats that support antenna augmentation that are configured for the UE 502. In this case, the UE 502 may perform a CSF evaluation associated with antenna augmentation for the UE 502.

In some aspects, the UE 502 may perform a Uu CSF report evaluation that reflects an antenna augmentation scenario for the UE 502. In order to perform a CSF report evaluation that reflects an antenna augmentation scenario, the UE 502 may determine CSF based on the CSI-RS received from the network node 110 by the UE 502 and/or the CSI-RS samples received from the CD 504. For example, the CSF may include CSI, such as a CQI, a PMI, a CRI, an LI, an RI, and/or measurement information, among other examples. In some aspects, the UE 502 may perform an extended CSF evaluation for a CSF report that supports antenna augmentation (e.g., a CSF report of a CSI report type that supports antenna augmentation). In the extended CSF evaluation, the UE 502 may evaluate CSF for multiple different subsets of antennas from an extended list of Rx antennas of the UE 502 and the CD 504 (e.g., or multiple CDs 504 in an example in which multiple CDs 504 that support antenna augmentation are paired with the UE 502). Each subset includes a different combination of Rx antennas from the extended list of Rx antennas of the UE 502 and the CD(s) 504. For example, each subset may include a different combination of one or more Rx antennas of the UE 502 and/or one or more Rx antennas of the CD(s) 504, and the UE 502 may use the CSI-RS samples received from the CD 504 together with the CSI-RS signal received by the UE 502 to determine and evaluate a respective CSF for each subset. The different subsets of Rx antennas evaluated by the UE 502 in the extended CSF evaluation for the CSF report that supports antenna augmentation may account for (e.g., be determined based at least in part on) complexity related restrictions and/or preferences for the UE 502, such as a maximum number of Rx antennas and/or a maximum rank, among other examples. In some aspects, in the extended CSF evaluation, the UE 502 may evaluate CSF without antenna augmentation (e.g., based only on the CSI-RS received by the Rx antennas of the UE 502), and the UE 502 may evaluate CSF with antenna augmentation for one or more combinations of one or more Rx antennas of the UE 502 and/or one or more augmentation antennas (e.g., one or more Rx antennas of at least one CD 504). For example, the UE 502 may evaluate CSF without antenna augmentation, and the UE 502 may evaluate CSF with antenna augmentation for multiple different combinations of Rx antennas of the UE 502 and/or augmentation antennas (e.g., one or more Rx antennas of at least one CD 504).

In some aspects, the UE 502 may determine whether to select antenna augmentation for the CSF report (e.g., the CSF report that supports antenna augmentation) based at least in part on evaluating the CSF without antenna augmentation and the CSF with antenna augmentation (e.g., using different combinations of Rx antennas of the UE 502 and augmentation antennas). For example, the UE 502 may compare the CSF evaluated without antenna augmentation and the CSF evaluated with antenna augmentation with different combinations of Rx antennas, and determine whether to select antenna augmentation or no antenna augmentation for the CSF report based at least in part on the comparison. In a case in which the UE 502 determines that antenna augmentation is selected for the CSF report, the UE 502 may also select a combination (e.g., a best combination) of one or more Rx antennas of the UE 502 and one or more augmentation antennas (e.g., one or more Rx antennas of the CD(s) 504) based at least in part on a comparison of the CSF evaluated for the different combinations (e.g., the different subsets of the extended list of Rx antennas of the UE 502 and the CD(s) 504).

As further shown in FIG. 5, and by reference number 540, the UE 502 may transmit, and the network node 110 may receive, the CSF report. In some aspects, the CSF report may be a CSF report that supports antenna augmentation. That is, the CSF report may be associated with a CSF report type that supports antenna augmentation (e.g., of the one or more CSF report types that support antenna augmentation configured for the UE 502). In some aspects, the CSF report that supports antenna augmentation (e.g., the CSF report associated with the CSF report type that supports antenna augmentation) may indicate whether antenna allocation is selected (e.g., by the UE 502) for the CSF report. For example, the CSF report that supports antenna augmentation may include an antenna augmentation indication that indicates whether antenna augmentation is selected for the CSF report. In some examples, the antenna augmentation indicator may include one bit or a bit field that indicates whether antenna augmentation is selected for the CSF report. For example, the antenna augmentation indicator may be a one-bit indicator (e.g., an antenna augmentation bit or an antenna augmentation flag) that is set to a first value (e.g., 1) to indicate that antenna augmentation is selected for the CSF report, or a second value (e.g. 0) to indicate the antenna augmentation is not selected for the CSF report. In some aspects, the antenna augmentation indicator, included in the CSF report that supports antenna augmentation, may enable the UE 502 to dynamically select whether or not to use antenna augmentation for a subsequent downlink allocation (e.g., downlink communication) for the UE 502. Accordingly, by indicating whether antenna augmentation is selected or not selected in each CSF report that supports antenna augmentation, the UE 502 may dynamically enable or disable antenna augmentation on a per downlink allocation (e.g., per downlink communication) basis.

The CSF report may also include CSF (e.g., CSF determined/evaluated by the UE 502) based on the CSI-RS received from the network node 110 by the UE 502 and/or the CSI-RS samples received from the CD(s) 504 by the UE 502. In some aspects, the CSF report may include CSF associated with a combination (e.g., a best combination) of one or more Rx antennas of the UE 502 and/or one or more Rx antennas of the CD(s) 504 selected by the UE 502. For example, the UE 502 may select the combination (e.g., the best combination) of one or more Rx antennas of the UE 502 and/or one or more Rx antennas of the CD(s) 504 based on the evaluation of the CSF for the different combinations. In such examples, the antenna augmentation indicator may indicate whether the CSF report finally relies on antenna augmentation or not (e.g., whether the CSF included in the CSF report transmitted to the network node 110 relies on antenna augmentation or not). For example, in a case in which antenna augmentation is not selected, the CSF report may include the CSF evaluated without antenna augmentation (e.g., for a combination of Rx antennas including only Rx antennas of the UE 502 and no augmentation antennas), and the antenna augmentation indicator may indicate that the CSF report does not rely on antenna augmentation. In another example in which antenna augmentation is selected, the CSF report may include CSF evaluated with antenna augmentation using a combination of one or more Rx antennas of the UE 502 and one or more augmentation antennas of the CD(s) 504, and the antenna augmentation indicator may indicate that the CSF report relies on antenna augmentation. In some aspects, in a case in which antenna augmentation is selected, the CSF report that supports antenna augmentation may indicate the CD(s) 504 selected to share one or more Rx antennas for antenna augmentation for the UE 502. For example, CSF report may indicate a CD ID for the CD 504 selected to share an Rx antenna as an augmentation antenna for the UE 502 (or multiple CD IDs in a case in which multiple CDs 504 are selected to share Rx antennas as augmentation antennas for the UE 502).

As further shown in FIG. 5, and by reference number 542, the UE 502 may transmit, and the CD 504 may receive, an indication of one or more Rx antennas of the CD 504 to be used for antenna augmentation for the UE 502. In some aspects, in a case in which antenna augmentation is selected for the CSF report, the UE 502 may indicate, to the CD 504, which Rx antennas of the CD 504 are to be shared over sidelink as augmentation antennas to assist the UE 502 with decoding a downlink communication. In an example in which multiple CDs 504 are selected to share Rx antennas for antenna augmentation for the UE 502, the UE 502 may transmit, to each of the multiple CDs 504, a respective indication of the one or more antennas of that CD 504 that are to be shared for antenna augmentation for the UE 502. The transmission of the indication of the Rx antenna(s) to the CD(s) 504 may be aligned with (e.g., transmitted at or near a same time as) the CSF reporting to the network node 110.

In some aspects, in addition to the UE 502 transmitting the CSF report that supports antenna augmentation to the network node 110, the UE 502 may also transmit, to the network node 110, another CSF report that does not support antenna augmentation. For example, as described above in connection with reference number 520, the network node 110 may configure the UE 502 with one or more CSF report formats with an option for antenna augmentation (e.g., the one or more CSF report formats that support antenna augmentation) and one or more CSF report formats without an option for antenna augmentation (e.g., the one or more CSF report formats that do not support antenna augmentation). In some examples, the UE 502 may transmit a CSF report that does not support antenna augmentation (e.g., a CSF report for downlink transmissions without antenna augmentation) to the network node 110 in connection with the UE 502 receiving, from the network node 110, a CSI-RS associated with a CSI-RS resource allocation that is associated with (e.g., triggers) the CSF report that does not support antenna augmentation. In such examples, the UE 502 may transmit two different types of CSF reports (e.g., the CSF report that supports antenna augmentation and the CSF report that does not support antenna augmentation) to the network node 110. The network node 110 may select between downlink transmissions for the UE 502 with and without antenna augmentation, and the network may determine different Tx parameters (e.g., MCS, RI, and PMI) for downlink transmissions for the UE 502 with and without antenna augmentation based at least in part on the different type of CSF reports received from the UE 502. In this way, the network node 110 may dynamically switch between enabling and disabling antenna augmentation on a per UE and per downlink allocation (e.g., downlink communication) basis.

As further shown in FIG. 5, and by reference number 544, the network node 110 may transmit DCI that schedules a downlink communication associated with the antenna augmentation (e.g., an AA-based downlink communication) for the UE 502. The network node 110 may schedule and transmit a downlink communication (e.g., a Uu downlink allocation) for the UE 502 based at least in part on the CSF report. In some aspects, the network node 110 may schedule and transmit the AA-based downlink communication for the UE 502 based at least in part on the antenna augmentation indicator, included in the AA-supporting CSF report, indicating that antenna augmentation is selected for the CSF report. In this case, the network node 110 may determine the MCS, the rank (e.g., RI), and the precoding (e.g., PMI) for the downlink communication (e.g., the AA-based downlink communication) based at least in part on the AA-supporting CSF report received from the UE 502.

In some aspects, the AA-based downlink communication for the UE 502 may be scheduled by the network node 110 using a special DCI based indication that informs both the UE 502 and the CD 504 regarding the antenna augmentation associated with the scheduled downlink transmission (e.g., the AA-based downlink communication). For example, the special DCI based indication may be transmitted via dedicated DCI signaling associated with antenna augmentation (e.g., as described above in connection with reference number 530). For example, as the dedicated DCI signaling may be companion device oriented DCI signaling dedicated to AA-supporting UE allocations, the dedicated DCI signaling may be used for AA-supporting UE data (e.g., PDSCH) allocations and for AA-related aperiodic CSF triggering and corresponding aperiodic CSI-RS resource allocation tracking in Uu downlink by the CD 504.

The UE 502 may receive the DCI scheduling the AA-based downlink communication for the UE 502. The CD 504 may also receive the DCI scheduling the AA-based downlink communication for the UE 502. For example, the CD 504 may receive the DCI scheduling the AA-based downlink communication for the UE 502 based at least in part on the indication in the dedicated DCI signaling that informs the CD 504 regarding the antenna augmentation associated with the scheduled downlink communication. In some aspects, the CD 504 may decode the DCI based at least in part on the context information for decoding the DCI transmitted to the CD 504 by the UE 502 (e.g., as discussed in connection with reference number 528). For example, the context information may indicate one or more parameters (e.g., RRC configuration parameters) that enable the companion device to decode the DCI and extract scheduling information for the AA-based downlink communication, and the CD 504 may decode the DCI and extract the scheduling information based at least in part on the one or more parameters indicated in the context information.

As further shown in FIG. 5, and by reference number 546, the network node 110 may transmit the downlink communication (e.g., the AA-based downlink communication). The downlink communication (e.g., the AA-based downlink communication) may be intended (e.g., targeted) for the UE 502. The network node 110 may transmit the AA-based downlink communication using the MCS, rank (e.g., RI), and precoding (e.g., PMI) determined based at least in part on the AA-supporting CSF report received from the UE 502. The UE 502 may receive the AA-based downlink communication, or at least a portion of the AA-based downlink communication, based at least in part on the scheduling information included in the DCI. The network node 110 may also receive the AA-based downlink communication, or at least a portion of the AA-based downlink communication based at least in part on the scheduling information included in the DCI. In some aspects, the UE 502 may receive, via one or more Rx antennas of the UE 502, one or more first signals associated with the downlink communication, and the CD 504 may receive, via one or more Rx antennas of the CD 504 (e.g., one or more Rx antennas of the CD 504 that are being shared as augmentation antennas for the UE 502), one or more second signals associated with the downlink communication.

The CD 504 may extract samples of the downlink communication (e.g., samples of the one or more second signals) and share the samples with the UE 502. For example, the CD 504 may extract and share the samples in a similar manner as described above in connection with FIG. 4. In some examples, only a subset of REs that are allocated for the downlink communication are extracted, sampled, compressed and forwarded to the UE 502 over sidelink by the CD 504. In some other examples, the entire OFDM symbols are extracted, sampled, compressed, and forwarded to the UE 502 over sidelink by the CD 504. The sampling of the entire OFDM symbol may be less efficient than sampling the subset of REs, but the sampling of the entire OFDM symbol allows for a direct time domain sampling for lower complexity at the CD 504.

As further shown in FIG. 5, and by reference number 548, the CD 504 may autonomously determine a sidelink allocation size for sharing the samples of the downlink communication (e.g., the samples of the one or more second signals). For example, the CD 504 may autonomously determine (e.g., calculate or select) an allocation size for a sidelink communication including the samples. In some examples, the CD 504 may determine (e.g., calculate or select) the allocation size based at least in part on context information received by the CD 504 from the UE 502 (e.g., context information configured to the CD 504 by the UE 502).

As shown by reference number 550, the CD 504 may transmit, and the UE 502 may receive, an indication of the allocation size. In some aspects, the CD 504 may indicate the allocation size for the sidelink communication including the samples of the downlink communication (e.g., the samples of the one or more second signals) in sidelink control information that precedes the sidelink communication including the samples. For example, the CD 504 may transmit, and the UE 502 may receive, sidelink control information that indicates the allocation size of the sidelink communication including the samples prior to transmission of the sidelink communication including the samples.

As shown by reference number 552, the CD 504 may transmit, and the UE 502 may receive, the samples of the downlink communication (e.g., the samples of the one or more second signals). For example, the CD 504 may transmit, and the UE 502 may receive, a sidelink communication (e.g., a PSSCH communication) including the samples. The size of the sidelink communication including the samples may correspond to the allocation size indicated in the sidelink control information prior to the transmission of the sidelink communication. In some aspects, the CD 504 may transmit the sidelink communication including the samples at a time offset from reception of the downlink communication (e.g., the one or more second signals associated with the downlink communication) in accordance with a sidelink transmission timing rule. In such examples, the CD 504 and the UE 502 may derive the sidelink transmission timing (for the CD 504) and reception timing (for the UE 502) relative to the downlink communication reception based at least in part on the sidelink transmission timing rule. For example, the sidelink transmission timing rule may be a predefined sidelink transmission timing rule. In some examples, the sidelink transmission timing rule may indicate the time offset between reception of the downlink communication and the transmission of the sidelink communication including the samples. In some examples, sidelink channel access by the CD 504 can be immediate on the sidelink resources semi-persistently configured for the CD 504 by the UE 502. In such examples, the sidelink transmission timing rule enables the UE 502 to align the reception of the sidelink communication including the samples with the transmission of the sidelink communication by the CD 504. In some examples, the samples of the downlink communication (e.g., the samples of the one or more second signals) may include samples of extracted REs of the downlink communication or samples of entire OFDM symbols of the downlink communication.

As further shown in FIG. 5, and by reference number 554, the UE 502 may decode the downlink communication. The UE 502 may decode the downlink communication based at least in part on the one or more first signals associated with the downlink communication received from the network node 110 via the one or more Rx antennas of the UE 502 and the samples received from the CD 504 (e.g., the samples of the one or more second signals received via the augmentation antennas shared by the CD 504).

As further shown in FIG. 5, and by reference number 556, the UE 502 may transmit, and the network node 110 may receive, ACK/NACK feedback for the downlink communication. In some examples, the UE 502 may transmit, to the network node 110, ACK feedback in connection with the UE 502 successfully decoding the downlink communication. In some examples, the UE 502 may transmit, to the network node 110, NACK feedback in connection with unsuccessful decoding of the downlink communication by the UE 502.

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 502 and/or UE 120) performs operations associated with antenna augmentation for downlink communications.

As shown in FIG. 6, in some aspects, process 600 may include transmitting, to a network node, capability information indicating an antenna augmentation capability of the UE (block 610). For example, the UE (e.g., using transmission component 904 and/or communication manager 906, depicted in FIG. 9) may transmit, to a network node, capability information indicating an antenna augmentation capability of the UE, as described above.

As further shown in FIG. 6, in some aspects, process 600 may include transmitting, to the network node, an indication of a companion device that supports antenna augmentation for the UE (block 620). For example, the UE (e.g., using transmission component 904 and/or communication manager 906, depicted in FIG. 9) may transmit, to the network node, an indication of a companion device that supports antenna augmentation for the UE, as described above.

As further shown in FIG. 6, in some aspects, process 600 may include receiving, from the network node, configuration information indicating one or more CSF report formats that support antenna augmentation (block 630). For example, the UE (e.g., using reception component 902 and/or communication manager 906, depicted in FIG. 9) may receive, from the network node, configuration information indicating one or more CSF report formats that support antenna augmentation, as described above.

Process 600 may include additional aspects, such as any single aspect or any combination of aspects described below and/or in connection with one or more other processes described elsewhere herein.

In a first aspect, the capability information indicates at least one of a minimum latency constraint for scheduling a downlink communication associated with antenna augmentation, a minimum latency constraint for decoding a downlink communication associated with antenna augmentation, a minimum latency constraint for ACK/NACK feedback reporting for a downlink communication associated with antenna augmentation, or a minimum latency constraint for extended CSF reporting associated with antenna augmentation.

In a second aspect, alone or in combination with the first aspect, process 600 includes receiving, from the companion device, companion device capability information indicating a capability of the companion device for supporting antenna augmentation for the UE.

In a third aspect, alone or in combination with one or more of the first and second aspects, the companion device capability information indicates at least one of a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.

In a fourth aspect, alone or in combination with one or more of the first through third aspects, the indication of the companion device includes a companion device identifier associated with the companion device.

In a fifth aspect, alone or in combination with one or more of the first through fourth aspects, the indication of the companion device includes a request for a configuration of the one or more CSF report formats that support antenna augmentation.

In a sixth aspect, alone or in combination with one or more of the first through fifth aspects, the configuration information indicates the one or more CSF report formats that support antenna augmentation and one or more other CSF formats that do not support antenna augmentation.

In a seventh aspect, alone or in combination with one or more of the first through sixth aspects, process 600 includes receiving, from the network node, a configuration of a set of sidelink resources associated with the UE and the companion device, and transmitting, to the companion device, an indication of sidelink resources, of the set of sidelink resources, for the companion device.

In an eighth aspect, alone or in combination with one or more of the first through seventh aspects, process 600 includes receiving, from the network node, one or more CSI-RS resource configurations, and transmitting, to the companion device, at least one CSI-RS resource configuration of the one or more CSI-RS resource configurations.

In a ninth aspect, alone or in combination with one or more of the first through eighth aspects, process 600 includes receiving, from the network node, a CSI-RS associated with the at least one CSI-RS resource configuration, and receiving, from the companion device, CSI-RS samples associated with the CSI-RS.

In a tenth aspect, alone or in combination with one or more of the first through ninth aspects, process 600 includes receiving, from the companion device, an indication of an allocation size associated with the CSI-RS samples.

In an eleventh aspect, alone or in combination with one or more of the first through tenth aspects, receiving the CSI-RS samples includes receiving the CSI-RS samples at a time offset from the CSI-RS in accordance with a sidelink transmission timing rule.

In a twelfth aspect, alone or in combination with one or more of the first through eleventh aspects, the CSI-RS is an aperiodic CSI-RS, the at least one CSI-RS resource configuration includes an aperiodic CSI-RS resource configuration associated with the aperiodic CSI-RS, and process 600 includes transmitting, to the companion device, context information for decoding DCI that schedules the aperiodic CSI-RS, and an indication of one or more CSI triggering states associated with the aperiodic CSI-RS resource configuration, and receiving, via dedicated DCI signaling associated with antenna augmentation, the DCI that schedules the aperiodic CSI-RS.

In a thirteenth aspect, alone or in combination with one or more of the first through twelfth aspects, process 600 includes transmitting, to the network node, a CSF report associated with a CSF report format of the one or more CSF report formats that support antenna augmentation, wherein the CSF report includes CSF based on at least one of the CSI-RS received from the network node or the CSI-RS samples received from the companion device, and an antenna augmentation indication that indicates whether antenna augmentation is selected for the CSF report.

In a fourteenth aspect, alone or in combination with one or more of the first through thirteenth aspects, process 600 includes evaluating CSF without antenna augmentation and CSF associated with antenna augmentation using one or more antennas of the companion device to select the CSF included in the CSF report.

In a fifteenth aspect, alone or in combination with one or more of the first through fourteenth aspects, the antenna augmentation indication indicates that the antenna augmentation is selected for the CSF report, and the CSF report indicates a companion device identifier associated with the companion device.

In a sixteenth aspect, alone or in combination with one or more of the first through fifteenth aspects, the antenna augmentation indication indicates that the antenna augmentation is selected for the CSF report, and process 600 includes transmitting, to the companion device, an indication of one or more antennas of the companion device to be used for antenna augmentation.

In a seventeenth aspect, alone or in combination with one or more of the first through sixteenth aspects, the antenna augmentation indication indicates that the antenna augmentation is selected for the CSF report, and process 600 includes receiving, from the network node, one or more first signals associated with a downlink communication, and receiving, from the companion device, samples of one or more second signals associated with the downlink communication.

In an eighteenth aspect, alone or in combination with one or more of the first through seventeenth aspects, process 600 includes receiving, via dedicated DCI signaling associated with antenna augmentation, DCI that schedules the downlink communication.

In a nineteenth aspect, alone or in combination with one or more of the first through eighteenth aspects, process 600 includes transmitting, to the companion device, one or more parameters that enable the companion device to extract scheduling information for the downlink communication from the DCI.

In a twentieth aspect, alone or in combination with one or more of the first through nineteenth aspects, process 600 includes receiving, from the companion device, an indication of an allocation size associated with the samples of the one or more second signals associated with the downlink communication.

In a twenty-first aspect, alone or in combination with one or more of the first through twentieth aspects, receiving the samples of the one or more second signals associated with the downlink communication includes receiving the samples at a time offset from the downlink communication in accordance with a sidelink transmission timing rule.

In a twenty-second aspect, alone or in combination with one or more of the first through twenty-first aspects, process 600 includes decoding the downlink communication based at least in part on the one or more first signals received from the network node and the samples received from the companion device.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with antenna augmentation for downlink communications.

As shown in FIG. 7, in some aspects, process 700 may include receiving, from a UE, capability information indicating an antenna augmentation capability of the UE (block 710). For example, the network node (e.g., using reception component 1002 and/or communication manager 1006, depicted in FIG. 10) may receive, from a UE, capability information indicating an antenna augmentation capability of the UE, as described above.

As further shown in FIG. 7, in some aspects, process 700 may include receiving, from the UE, an indication of a companion device that supports antenna augmentation for the UE (block 720). For example, the network node (e.g., using reception component 1002 and/or communication manager 1006, depicted in FIG. 10) may receive, from the UE, an indication of a companion device that supports antenna augmentation for the UE, as described above.

As further shown in FIG. 7, in some aspects, process 700 may include transmitting, to the UE, configuration information indicating one or more CSF report formats that support antenna augmentation (block 730). For example, the network node (e.g., using transmission component 1004 and/or communication manager 1006, depicted in FIG. 10) may transmit, to the UE, configuration information indicating one or more CSF report formats that support antenna augmentation, as described above.

Process 700 may include additional aspects, such as any single aspect or any combination of aspects described below and/or in connection with one or more other processes described elsewhere herein.

In a first aspect, the capability information indicates at least one of a minimum latency constraint for scheduling a downlink communication associated with antenna augmentation, a minimum latency constraint for decoding a downlink communication associated with antenna augmentation, a minimum latency constraint for ACK/NACK feedback reporting for a downlink communication associated with antenna augmentation, or a minimum latency constraint for extended CSF reporting associated with antenna augmentation.

In a second aspect, alone or in combination with the first aspect, process 700 includes receiving, from the companion device, companion device capability information indicating a capability of the companion device for supporting antenna augmentation for the UE.

In a third aspect, alone or in combination with one or more of the first and second aspects, the companion device capability information indicates at least one of a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.

In a fourth aspect, alone or in combination with one or more of the first through third aspects, the indication of the companion device includes a companion device identifier associated with the companion device.

In a fifth aspect, alone or in combination with one or more of the first through fourth aspects, the indication of the companion device includes a request for a configuration of the one or more CSF report formats that support antenna augmentation.

In a sixth aspect, alone or in combination with one or more of the first through fifth aspects, the configuration information indicates the one or more CSF report formats that support antenna augmentation and one or more other CSF formats that do not support antenna augmentation.

In a seventh aspect, alone or in combination with one or more of the first through sixth aspects, process 700 includes transmitting, to the UE, a configuration of a set of sidelink resources associated with the UE and the companion device.

In an eighth aspect, alone or in combination with one or more of the first through seventh aspects, process 700 includes transmitting, to the UE, one or more CSI-RS resource configurations.

In a ninth aspect, alone or in combination with one or more of the first through eighth aspects, process 700 includes transmitting a CSI-RS associated with at least one CSI-RS resource configuration of the one or more CSI-RS resource configurations.

In a tenth aspect, alone or in combination with one or more of the first through ninth aspects, the CSI-RS is an aperiodic CSI-RS, and process 700 includes transmitting, via dedicated DCI signaling associated with antenna augmentation, DCI that schedules the aperiodic CSI-RS.

In an eleventh aspect, alone or in combination with one or more of the first through tenth aspects, process 700 includes receiving, from the UE, a CSF report associated with a CSF report format of the one or more CSF report formats that support antenna augmentation, wherein the CSF report includes CSF based associated with the CSI-RS, and an antenna augmentation indication that indicates whether antenna augmentation is selected for the CSF report.

In a twelfth aspect, alone or in combination with one or more of the first through eleventh aspects, the antenna augmentation indication indicates that the antenna augmentation is selected for the CSF report, and the CSF report indicates a companion device identifier associated with the companion device.

In a thirteenth aspect, alone or in combination with one or more of the first through twelfth aspects, the antenna augmentation indication indicates that the antenna augmentation is selected for the CSF report, and process 700 includes transmitting, via dedicated DCI signaling associated with antenna augmentation, DCI that schedules a downlink communication associated with antenna augmentation, and transmitting the downlink communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a companion device or an apparatus of a companion device, in accordance with the present disclosure. Example process 800 is an example where the apparatus or the companion device (e.g., CD 504 and/or UE 120) performs operations associated with antenna augmentation for downlink communications.

As shown in FIG. 8, in some aspects, process 800 may include transmitting, to a UE, capability information indicating a capability of the companion device for supporting antenna augmentation for the UE (block 810). For example, the companion device (e.g., using transmission component 1104 and/or communication manager 1106, depicted in FIG. 11) may transmit, to a UE, capability information indicating a capability of the companion device for supporting antenna augmentation for the UE, as described above.

As further shown in FIG. 8, in some aspects, process 800 may include receiving, from the UE, at least one CSI-RS resource configuration (block 820). For example, the companion device (e.g., using reception component 1102 and/or communication manager 1106, depicted in FIG. 11) may receive, from the UE, at least one CSI-RS resource configuration, as described above.

As further shown in FIG. 8, in some aspects, process 800 may include receiving, from a network node, a CSI-RS associated with the at least one CSI-RS resource configuration (block 830). For example, the companion device (e.g., using reception component 1102 and/or communication manager 1106, depicted in FIG. 11) may receive, from a network node, a CSI-RS associated with the at least one CSI-RS resource configuration, as described above.

As further shown in FIG. 8, in some aspects, process 800 may include transmitting, to the UE, CSI-RS samples associated with the CSI-RS (block 840). For example, the companion device (e.g., using transmission component 1104 and/or communication manager 1106, depicted in FIG. 11) may transmit, to the UE, CSI-RS samples associated with the CSI-RS, as described above.

Process 800 may include additional aspects, such as any single aspect or any combination of aspects described below and/or in connection with one or more other processes described elsewhere herein.

In a first aspect, the capability information indicates at least one of a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.

In a second aspect, alone or in combination with the first aspect, process 800 includes receiving, from the UE, an indication of sidelink resources for the companion device.

In a third aspect, alone or in combination with one or more of the first and second aspects, process 800 includes transmitting, to the UE, an indication of an allocation size associated with the CSI-RS samples.

In a fourth aspect, alone or in combination with one or more of the first through third aspects, process 800 includes calculating the allocation size associated with the CSI-RS samples.

In a fifth aspect, alone or in combination with one or more of the first through fourth aspects, transmitting the CSI-RS samples includes transmitting the CSI-RS samples at a time offset from the CSI-RS in accordance with a sidelink transmission timing rule.

In a sixth aspect, alone or in combination with one or more of the first through fifth aspects, the CSI-RS is an aperiodic CSI-RS, the at least one CSI-RS resource configuration includes an aperiodic CSI-RS resource configuration associated with the aperiodic CSI-RS, and process 800 includes receiving, from the UE, context information for decoding DCI that schedules the aperiodic CSI-RS, and an indication of one or more CSI triggering states associated with the aperiodic CSI-RS resource configuration, and receiving, via dedicated DCI signaling associated with antenna augmentation, the DCI that schedules the aperiodic CSI-RS.

In a seventh aspect, alone or in combination with one or more of the first through sixth aspects, process 800 includes receiving, from the UE, an indication of one or more antennas of the companion device to be used for antenna augmentation for the UE.

In an eighth aspect, alone or in combination with one or more of the first through seventh aspects, process 800 includes receiving, from the network node, one or more signals associated with a downlink communication for the UE, and transmitting, to the UE, samples of the one or more signals associated with the downlink communication.

In a ninth aspect, alone or in combination with one or more of the first through eighth aspects, process 800 includes receiving, via dedicated DCI signaling associated with antenna augmentation, DCI that schedules the downlink communication.

In a tenth aspect, alone or in combination with one or more of the first through ninth aspects, process 800 includes receiving, from the UE, one or more parameters associated with extracting scheduling information for the downlink communication from the DCI, and extracting the scheduling information for the downlink communication from the DCI based at least in part on the one or more parameters.

In an eleventh aspect, alone or in combination with one or more of the first through tenth aspects, process 800 includes transmitting, to the UE, an indication of an allocation size associated with the samples of the one or more signals associated with the downlink communication.

In a twelfth aspect, alone or in combination with one or more of the first through eleventh aspects, process 800 includes calculating the allocation size associated with the samples of the one or more signals associated with the downlink communication.

In a thirteenth aspect, alone or in combination with one or more of the first through twelfth aspects, transmitting the samples of the one or more signals associated with the downlink communication includes transmitting the samples at a time offset from the downlink communication in accordance with a sidelink transmission timing rule.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-5. Additionally, or alternatively, the apparatus 900 may be configured to perform one or more processes described herein, such as process 600 of FIG. 6, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a network node, capability information indicating an antenna augmentation capability of the UE. The transmission component 904 may transmit, to the network node, an indication of a companion device that supports antenna augmentation for the UE. The reception component 902 may receive, from the network node, configuration information indicating one or more CSF report formats that support antenna augmentation.

The reception component 902 may receive, from the companion device, companion device capability information indicating a capability of the companion device for supporting antenna augmentation for the UE.

The reception component 902 may receive, from the network node, a configuration of a set of sidelink resources associated with the UE and the companion device.

The transmission component 904 may transmit, to the companion device, an indication of sidelink resources, of the set of sidelink resources, for the companion device.

The reception component 902 may receive, from the network node, one or more CSI-RS resource configurations.

The transmission component 904 may transmit, to the companion device, at least one CSI-RS resource configuration of the one or more CSI-RS resource configurations.

The reception component 902 may receive, from the network node, a CSI-RS associated with the at least one CSI-RS resource configuration.

The reception component 902 may receive, from the companion device, CSI-RS samples associated with the CSI-RS.

The reception component 902 may receive, from the companion device, an indication of an allocation size associated with the CSI-RS samples.

The transmission component 904 may transmit, to the network node, a CSF report associated with a CSF report format of the one or more CSF report formats that support antenna augmentation, wherein the CSF report includes CSF based on at least one of the CSI-RS received from the network node or the CSI-RS samples received from the companion device, and an antenna augmentation indication that indicates whether antenna augmentation is selected for the CSF report.

The transmission component 904 may transmit, to the companion device, context information for decoding DCI that schedules the aperiodic CSI-RS, and an indication of one or more CSI triggering states associated with the aperiodic CSI-RS resource configuration.

The reception component 902 may receive, via dedicated DCI signaling associated with antenna augmentation, the DCI that schedules the aperiodic CSI-RS.

The communication manager 906 may evaluate CSF without antenna augmentation and CSF associated with antenna augmentation using one or more antennas of the companion device to select the CSF included in the CSF report.

The transmission component 904 may transmit, to the companion device, an indication of one or more antennas of the companion device to be used for antenna augmentation.

The reception component 902 may receive, from the network node, one or more first signals associated with a downlink communication.

The reception component 902 may receive, from the companion device, samples of one or more second signals associated with the downlink communication.

The reception component 902 may receive, via dedicated DCI signaling associated with antenna augmentation, DCI that schedules the downlink communication.

The transmission component 904 may transmit, to the companion device, one or more parameters that enable the companion device to extract scheduling information for the downlink communication from the DCI.

The reception component 902 may receive, from the companion device, an indication of an allocation size associated with the samples of the one or more second signals associated with the downlink communication.

The communication manager 906 may decode the downlink communication based at least in part on the one or more first signals received from the network node and the samples received from the companion device.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-5. Additionally, or alternatively, the apparatus 1000 may be configured to perform one or more processes described herein, such as process 700 of FIG. 7, or a combination thereof. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a UE, capability information indicating an antenna augmentation capability of the UE. The reception component 1002 may receive, from the UE, an indication of a companion device that supports antenna augmentation for the UE. The transmission component 1004 may transmit, to the UE, configuration information indicating one or more CSF report formats that support antenna augmentation.

The reception component 1002 may receive, from the companion device, companion device capability information indicating a capability of the companion device for supporting antenna augmentation for the UE.

The transmission component 1004 may transmit, to the UE, a configuration of a set of sidelink resources associated with the UE and the companion device.

The transmission component 1004 may transmit, to the UE, one or more CSI-RS resource configurations.

The transmission component 1004 may transmit a CSI-RS associated with at least one CSI-RS resource configuration of the one or more CSI-RS resource configurations.

The transmission component 1004 may transmit, via dedicated DCI signaling associated with antenna augmentation, DCI that schedules the aperiodic CSI-RS.

The reception component 1002 may receive, from the UE, a CSF report associated with a CSF report format of the one or more CSF report formats that support antenna augmentation, wherein the CSF report includes CSF based associated with the CSI-RS, and an antenna augmentation indication that indicates whether antenna augmentation is selected for the CSF report.

The transmission component 1004 may transmit, via dedicated DCI signaling associated with antenna augmentation, DCI that schedules a downlink communication associated with antenna augmentation.

The transmission component 1004 may transmit the downlink communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a companion device, or a companion device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the companion device.

In some aspects, the apparatus 1100 may be configured to perform one or more operations described herein in connection with FIGS. 3-5. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE described in connection with FIG. 1.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE, capability information indicating a capability of the companion device for supporting antenna augmentation for the UE. The reception component 1102 may receive, from the UE, at least one CSI-RS resource configuration. The reception component 1102 may receive, from a network node, a CSI-RS associated with the at least one CSI-RS resource configuration. The transmission component 1104 may transmit, to the UE, CSI-RS samples associated with the CSI-RS.

The reception component 1102 may receive, from the UE, an indication of sidelink resources for the companion device.

The transmission component 1104 may transmit, to the UE, an indication of an allocation size associated with the CSI-RS samples.

The communication manager 1106 may calculate the allocation size associated with the CSI-RS samples.

The reception component 1102 may receive, from the UE, context information for decoding DCI that schedules the aperiodic CSI-RS, and an indication of one or more CSI triggering states associated with the aperiodic CSI-RS resource configuration.

The reception component 1102 may receive, via dedicated DCI signaling associated with antenna augmentation, the DCI that schedules the aperiodic CSI-RS.

The reception component 1102 may receive, from the UE, an indication of one or more antennas of the companion device to be used for antenna augmentation for the UE.

The reception component 1102 may receive, from the network node, one or more signals associated with a downlink communication for the UE.

The transmission component 1104 may transmit, to the UE, samples of the one or more signals associated with the downlink communication.

The reception component 1102 may receive, via dedicated DCI signaling associated with antenna augmentation, DCI that schedules the downlink communication.

The reception component 1102 may receive, from the UE, one or more parameters associated with extracting scheduling information for the downlink communication from the DCI.

The communication manager 1106 may extract the scheduling information for the downlink communication from the DCI based at least in part on the one or more parameters.

The transmission component 1104 may transmit, to the UE, an indication of an allocation size associated with the samples of the one or more signals associated with the downlink communication.

The communication manager 1106 may calculate the allocation size associated with the samples of the one or more signals associated with the downlink communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: transmitting, to a network node, capability information indicating an antenna augmentation capability of the UE; transmitting, to the network node, an indication of a companion device that supports antenna augmentation for the UE; and receiving, from the network node, configuration information indicating one or more channel state feedback (CSF) report formats that support antenna augmentation.
Aspect 2: The method of Aspect 1, wherein the capability information indicates at least one of: a minimum latency constraint for scheduling a downlink communication associated with antenna augmentation, a minimum latency constraint for decoding a downlink communication associated with antenna augmentation, a minimum latency constraint for acknowledgment or negative acknowledgment (ACK/NACK) feedback reporting for a downlink communication associated with antenna augmentation, or a minimum latency constraint for extended CSF reporting associated with antenna augmentation.
Aspect 3: The method of any of Aspects 1-2, further comprising: receiving, from the companion device, companion device capability information indicating a capability of the companion device for supporting antenna augmentation for the UE.
Aspect 4: The method of Aspect 3, wherein the companion device capability information indicates at least one of: a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.
Aspect 5: The method of any of Aspects 1-4, wherein the indication of the companion device includes a companion device identifier associated with the companion device.
Aspect 6: The method of any of Aspects 1-5, wherein the indication of the companion device includes a request for a configuration of the one or more CSF report formats that support antenna augmentation.
Aspect 7: The method of any of Aspects 1-6, wherein the configuration information indicates the one or more CSF report formats that support antenna augmentation and one or more other CSF formats that do not support antenna augmentation.
Aspect 8: The method of any of Aspects 1-7, further comprising: receiving, from the network node, a configuration of a set of sidelink resources associated with the UE and the companion device; and transmitting, to the companion device, an indication of sidelink resources, of the set of sidelink resources, for the companion device.
Aspect 9: The method of any of Aspects 1-8, further comprising: receiving, from the network node, one or more channel state information (CSI) reference signal (CSI-RS) resource configurations; and transmitting, to the companion device, at least one CSI-RS resource configuration of the one or more CSI-RS resource configurations.
Aspect 10: The method of Aspect 9, further comprising: receiving, from the network node, a CSI-RS associated with the at least one CSI-RS resource configuration; and receiving, from the companion device, CSI-RS samples associated with the CSI-RS.
Aspect 11: The method of Aspect 10, further comprising: receiving, from the companion device, an indication of an allocation size associated with the CSI-RS samples.
Aspect 12: The method of any of Aspects 10-11, wherein receiving the CSI-RS samples comprises: receiving the CSI-RS samples at a time offset from the CSI-RS in accordance with a sidelink transmission timing rule.
Aspect 13: The method of any of Aspects 10-12, wherein the CSI-RS is an aperiodic CSI-RS, wherein the at least one CSI-RS resource configuration includes an aperiodic CSI-RS resource configuration associated with the aperiodic CSI-RS, and further comprising: transmitting, to the companion device, context information for decoding downlink control information (DCI) that schedules the aperiodic CSI-RS, and an indication of one or more CSI triggering states associated with the aperiodic CSI-RS resource configuration; and receiving, via dedicated DCI signaling associated with antenna augmentation, the DCI that schedules the aperiodic CSI-RS.
Aspect 14: The method of any of Aspects 10-13, further comprising: transmitting, to the network node, a CSF report associated with a CSF report format of the one or more CSF report formats that support antenna augmentation, wherein the CSF report includes: CSF based on at least one of the CSI-RS received from the network node or the CSI-RS samples received from the companion device, and an antenna augmentation indication that indicates whether antenna augmentation is selected for the CSF report.
Aspect 15: The method of Aspect 14, further comprising: evaluating CSF without antenna augmentation and CSF associated with antenna augmentation using one or more antennas of the companion device to select the CSF included in the CSF report.
Aspect 16: The method of any of Aspects 14-15, wherein the antenna augmentation indication indicates that the antenna augmentation is selected for the CSF report, and wherein the CSF report indicates a companion device identifier associated with the companion device.
Aspect 17: The method of any of Aspects 14-16, wherein the antenna augmentation indication indicates that the antenna augmentation is selected for the CSF report, and further comprising: transmitting, to the companion device, an indication of one or more antennas of the companion device to be used for antenna augmentation.
Aspect 18: The method of any of Aspects 14-17, wherein the antenna augmentation indication indicates that the antenna augmentation is selected for the CSF report, and further comprising: receiving, from the network node, one or more first signals associated with a downlink communication; and receiving, from the companion device, samples of one or more second signals associated with the downlink communication.
Aspect 19: The method of Aspect 18, further comprising: receiving, via dedicated downlink control information (DCI) signaling associated with antenna augmentation, DCI that schedules the downlink communication.
Aspect 20: The method of Aspect 19, further comprising: transmitting, to the companion device, one or more parameters that enable the companion device to extract scheduling information for the downlink communication from the DCI.
Aspect 21: The method of any of Aspects 18-20, further comprising: receiving, from the companion device, an indication of an allocation size associated with the samples of the one or more second signals associated with the downlink communication.
Aspect 22: The method of any of Aspects 18-21, wherein receiving the samples of the one or more second signals associated with the downlink communication comprises: receiving the samples at a time offset from the downlink communication in accordance with a sidelink transmission timing rule.
Aspect 23: The method of any of Aspects 18-22, further comprising: decoding the downlink communication based at least in part on the one or more first signals received from the network node and the samples received from the companion device.
Aspect 24: A method of wireless communication performed by a network node, comprising: receiving, from a user equipment (UE), capability information indicating an antenna augmentation capability of the UE; receiving, from the UE, an indication of a companion device that supports antenna augmentation for the UE; and transmitting, to the UE, configuration information indicating one or more channel state feedback (CSF) report formats that support antenna augmentation.
Aspect 25: The method of Aspect 24, wherein the capability information indicates at least one of: a minimum latency constraint for scheduling a downlink communication associated with antenna augmentation, a minimum latency constraint for decoding a downlink communication associated with antenna augmentation, a minimum latency constraint for acknowledgment or negative acknowledgment (ACK/NACK) feedback reporting for a downlink communication associated with antenna augmentation, or a minimum latency constraint for extended CSF reporting associated with antenna augmentation.
Aspect 26: The method of any of Aspects 24-25, further comprising: receiving, from the companion device, companion device capability information indicating a capability of the companion device for supporting antenna augmentation for the UE.
Aspect 27: The method of Aspect 26, wherein the companion device capability information indicates at least one of: a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.
Aspect 28: The method of any of Aspects 24-27, wherein the indication of the companion device includes a companion device identifier associated with the companion device.
Aspect 29: The method of any of Aspects 24-28, wherein the indication of the companion device includes a request for a configuration of the one or more CSF report formats that support antenna augmentation.
Aspect 30: The method of any of Aspects 24-29, wherein the configuration information indicates the one or more CSF report formats that support antenna augmentation and one or more other CSF formats that do not support antenna augmentation.
Aspect 31: The method of any of Aspects 24-30, further comprising: transmitting, to the UE, a configuration of a set of sidelink resources associated with the UE and the companion device.
Aspect 32: The method of any of Aspects 24-31, further comprising: transmitting, to the UE, one or more channel state information (CSI) reference signal (CSI-RS) resource configurations.
Aspect 33: The method of Aspect 32, further comprising: transmitting a CSI-RS associated with at least one CSI-RS resource configuration of the one or more CSI-RS resource configurations.
Aspect 34: The method of Aspect 33, wherein the CSI-RS is an aperiodic CSI-RS, and further comprising: transmitting, via dedicated downlink control information (DCI) signaling associated with antenna augmentation, DCI that schedules the aperiodic CSI-RS.
Aspect 35: The method of any of Aspects 33-34, further comprising: receiving, from the UE, a CSF report associated with a CSF report format of the one or more CSF report formats that support antenna augmentation, wherein the CSF report includes: CSF based associated with the CSI-RS, and an antenna augmentation indication that indicates whether antenna augmentation is selected for the CSF report.
Aspect 36: The method of Aspect 35, wherein the antenna augmentation indication indicates that the antenna augmentation is selected for the CSF report, and wherein the CSF report indicates a companion device identifier associated with the companion device.
Aspect 37: The method of any of Aspects 35-36, wherein the antenna augmentation indication indicates that the antenna augmentation is selected for the CSF report, and further comprising: transmitting, via dedicated downlink control information (DCI) signaling associated with antenna augmentation, DCI that schedules a downlink communication associated with antenna augmentation; and transmitting the downlink communication.
Aspect 38: A method of wireless communication performed by a companion device, comprising: transmitting, to a user equipment (UE), capability information indicating a capability of the companion device for supporting antenna augmentation for the UE; receiving, from the UE, at least one channel state information (CSI) reference signal (CSI-RS) resource configuration; receiving, from a network node, a CSI-RS associated with the at least one CSI-RS resource configuration; and transmitting, to the UE, CSI-RS samples associated with the CSI-RS.
Aspect 39: The method of Aspect 38, wherein the capability information indicates at least one of: a maximum number of augmentation antennas to be shared for antenna augmentation for the UE, a minimum latency constraint for sharing samples of a downlink signal, a capability for extracting frequency domain resources before sharing samples of a downlink signal, a time domain or a frequency domain supported for sharing samples of a downlink signal, or a supported transmit waveform for sharing samples of a downlink signal.
Aspect 40: The method of any of Aspects 38-39, further comprising: receiving, from the UE, an indication of sidelink resources for the companion device.
Aspect 41: The method of any of Aspects 38-40, further comprising: transmitting, to the UE, an indication of an allocation size associated with the CSI-RS samples.
Aspect 42: The method of Aspect 41, further comprising: calculating the allocation size associated with the CSI-RS samples.
Aspect 43: The method of any of Aspects 38-42, wherein transmitting the CSI-RS samples comprises: transmitting the CSI-RS samples at a time offset from the CSI-RS in accordance with a sidelink transmission timing rule.
Aspect 44: The method of any of Aspects 38-43, wherein the CSI-RS is an aperiodic CSI-RS, wherein the at least one CSI-RS resource configuration includes an aperiodic CSI-RS resource configuration associated with the aperiodic CSI-RS, and further comprising: receiving, from the UE, context information for decoding downlink control information (DCI) that schedules the aperiodic CSI-RS, and an indication of one or more CSI triggering states associated with the aperiodic CSI-RS resource configuration; and receiving, via dedicated DCI signaling associated with antenna augmentation, the DCI that schedules the aperiodic CSI-RS.
Aspect 45: The method of any of Aspects 38-44, further comprising: receiving, from the UE, an indication of one or more antennas of the companion device to be used for antenna augmentation for the UE.
Aspect 46: The method of Aspect 45, further comprising: receiving, from the network node, one or more signals associated with a downlink communication for the UE; and transmitting, to the UE, samples of the one or more signals associated with the downlink communication.
Aspect 47: The method of Aspect 46, further comprising: receiving, via dedicated downlink control information (DCI) signaling associated with antenna augmentation, DCI that schedules the downlink communication.
Aspect 48: The method of Aspect 47, further comprising: receiving, from the UE, one or more parameters associated with extracting scheduling information for the downlink communication from the DCI; and extracting the scheduling information for the downlink communication from the DCI based at least in part on the one or more parameters.
Aspect 49: The method of any of Aspects 46-48, further comprising: transmitting, to the UE, an indication of an allocation size associated with the samples of the one or more signals associated with the downlink communication.
Aspect 50: The method of Aspect 49, further comprising: calculating the allocation size associated with the samples of the one or more signals associated with the downlink communication.
Aspect 51: The method of any of Aspects 46-50, wherein transmitting the samples of the one or more signals associated with the downlink communication comprises: transmitting the samples at a time offset from the downlink communication in accordance with a sidelink transmission timing rule.
Aspect 52: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.
Aspect 53: An apparatus for wireless communication at a device, the apparatus comprising one or more memories and one or more processors coupled to the one or more memories, the one or more processors configured to cause the device to perform the method of one or more of Aspects 1-51.
Aspect 54: An apparatus for wireless communication, the apparatus comprising at least one means for performing the method of one or more of Aspects 1-51.
Aspect 55: A non-transitory computer-readable medium storing code for wireless communication, the code comprising instructions executable by one or more processors to perform the method of one or more of Aspects 1-51.
Aspect 56: A non-transitory computer-readable medium storing a set of instructions for wireless communication, the set of instructions comprising one or more instructions that, when executed by one or more processors of a device, cause the device to perform the method of one or more of Aspects 1-51.
Aspect 57: A device for wireless communication, the device comprising a processing system that includes one or more processors and one or more memories coupled with the one or more processors, the processing system configured to cause the device to perform the method of one or more of Aspects 1-51.
Aspect 58: An apparatus for wireless communication at a device, the apparatus comprising one or more memories and one or more processors coupled to the one or more memories, the one or more processors individually or collectively configured to cause the device to perform the method of one or more of Aspects 1-51.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, individually or collectively configured to cause the UE to:
transmit, to a network node, capability information indicating an antenna augmentation capability of the UE;
transmit, to the network node, an indication of a companion device that supports antenna augmentation for the UE; and
receive, from the network node, configuration information indicating one or more channel state feedback (CSF) report formats that support antenna augmentation.

2. The UE of claim 1, wherein the capability information indicates at least one of:
a minimum latency constraint for scheduling a downlink communication associated with antenna augmentation,
a minimum latency constraint for decoding a downlink communication associated with antenna augmentation,
a minimum latency constraint for acknowledgment or negative acknowledgment (ACK/NACK) feedback reporting for a downlink communication associated with antenna augmentation, or
a minimum latency constraint for extended CSF reporting associated with antenna augmentation.

3. The UE of claim 1, wherein the one or more processors are individually or collectively configured to cause the UE to:
receive, from the companion device, companion device capability information indicating a capability of the companion device for supporting antenna augmentation for the UE.

4. The UE of claim 3, wherein the companion device capability information indicates at least one of:
a maximum number of augmentation antennas to be shared for antenna augmentation for the UE,
a minimum latency constraint for sharing samples of a downlink signal,
a capability for extracting frequency domain resources before sharing samples of a downlink signal,
a time domain or a frequency domain supported for sharing samples of a downlink signal, or
a supported transmit waveform for sharing samples of a downlink signal.

5. The UE of claim 1, wherein the indication of the companion device includes a companion device identifier associated with the companion device.

6. The UE of claim 1, wherein the indication of the companion device includes a request for a configuration of the one or more CSF report formats that support antenna augmentation.

7. The UE of claim 1, wherein the configuration information indicates the one or more CSF report formats that support antenna augmentation and one or more other CSF formats that do not support antenna augmentation.

8. The UE of claim 1, wherein the one or more processors are individually or collectively configured to cause the UE to:
receive, from the network node, a configuration of a set of sidelink resources associated with the UE and the companion device; and
transmit, to the companion device, an indication of sidelink resources, of the set of sidelink resources, for the companion device.

9. The UE of claim 1, wherein the one or more processors are individually or collectively configured to cause the UE to:
receive, from the network node, one or more channel state information (CSI) reference signal (CSI-RS) resource configurations; and
transmit, to the companion device, at least one CSI-RS resource configuration of the one or more CSI-RS resource configurations.

10. The UE of claim 9, wherein the one or more processors are individually or collectively configured to cause the UE to:
receive, from the network node, a CSI-RS associated with the at least one CSI-RS resource configuration; and
receive, from the companion device, CSI-RS samples associated with the CSI-RS.

11. The UE of claim 10, wherein the one or more processors are individually or collectively configured to cause the UE to:
receive, from the companion device, an indication of an allocation size associated with the CSI-RS samples.

12. The UE of claim 10, wherein the one or more processors, receive the CSI-RS samples, are individually or collectively configured to cause the UE to:
receive the CSI-RS samples at a time offset from the CSI-RS in accordance with a sidelink transmission timing rule.

13. The UE of claim 10, wherein the CSI-RS is an aperiodic CSI-RS, wherein the at least one CSI-RS resource configuration includes an aperiodic CSI-RS resource configuration associated with the aperiodic CSI-RS, and wherein the one or more processors are individually or collectively configured to cause the UE to:
transmit, to the companion device, context information for decoding downlink control information (DCI) that schedules the aperiodic CSI-RS, and an indication of one or more CSI triggering states associated with the aperiodic CSI-RS resource configuration; and
receive, via dedicated DCI signaling associated with antenna augmentation, the DCI that schedules the aperiodic CSI-RS.

14. The UE of claim 10, wherein the one or more processors are individually or collectively configured to cause the UE to:
transmit, to the network node, a CSF report associated with a CSF report format of the one or more CSF report formats that support antenna augmentation, wherein the CSF report includes:
CSF based on at least one of the CSI-RS received from the network node or the CSI-RS samples received from the companion device, and
an antenna augmentation indication that indicates whether antenna augmentation is selected for the CSF report.

15. The UE of claim 14, wherein the one or more processors are individually or collectively configured to cause the UE to:
evaluate CSF without antenna augmentation and CSF associated with antenna augmentation using one or more antennas of the companion device to select the CSF included in the CSF report.

16. The UE of claim 14, wherein the antenna augmentation indication indicates that the antenna augmentation is selected for the CSF report, wherein the CSF report indicates a companion device identifier associated with the companion device, and wherein the one or more processors are individually or collectively configured to cause the UE to:
transmit, to the companion device, an indication of one or more antennas of the companion device to be used for antenna augmentation.

17. The UE of claim 14, wherein the antenna augmentation indication indicates that the antenna augmentation is selected for the CSF report, and wherein the one or more processors are individually or collectively configured to cause the UE to:
receive, via dedicated downlink control information (DCI) signaling associated with antenna augmentation, DCI that schedules a downlink communication;
receive, from the network node, one or more first signals associated with the downlink communication;
receive, from the companion device, samples of one or more second signals associated with the downlink communication; and
decode the downlink communication based at least in part on the one or more first signals received from the network node and the samples received from the companion device.

18. The UE of claim 17, wherein the one or more processors are individually or collectively configured to cause the UE to:
receive, from the companion device, an indication of an allocation size associated with the samples of the one or more second signals associated with the downlink communication.

19. A network node for wireless communication, comprising:
one or more memories; and
one or more processors, coupled to the one or more memories, individually or collectively configured to cause the network node to:
receive, from a user equipment (UE), capability information indicating an antenna augmentation capability of the UE;
receive, from the UE, an indication of a companion device that supports antenna augmentation for the UE; and
transmit, to the UE, configuration information indicating one or more channel state feedback (CSF) report formats that support antenna augmentation.

20. A companion device for wireless communication, comprising:
one or more memories; and
one or more processors, coupled to the one or more memories, individually or collectively configured to cause the companion device to:
transmit, to a user equipment (UE), capability information indicating a capability of the companion device for supporting antenna augmentation for the UE;
receive, from the UE, at least one channel state information (CSI) reference signal (CSI-RS) resource configuration;
receive, from a network node, a CSI-RS associated with the at least one CSI-RS resource configuration; and
transmit, to the UE, CSI-RS samples associated with the CSI-RS.
